(19) United States
(12) Patent Application Publication
(10) Pub. No.: US 2025/0139468 A1
(43) Pub. Date: May 1, 2025

(54) END-TO-END WORKFLOW FOR AUTOMATED NARRATIVE CREATION

(71) Applicant: Narratize, Inc., Crescent Springs, KY (US)

(72) Inventors: Kathryn Trauth Taylor, Taylor Mill, KY (US); Catherine O'Shea, Cincinnati, OH (US); Kara Uchtman, Cincinnati, OH (US); Stephen Taylor, Taylor Mill, KY (US)

(21) Appl. No.: 18/933,686

(22) Filed: Oct. 31, 2024

Related U.S. Application Data
(60) Provisional application No. 63/546,729, filed on Oct. 31, 2023.

(51) Int. Cl. G06N 5/025; H04N 21/85

(52) U.S. Cl. CPC G06N 5/025; H04N 21/85

(57) ABSTRACT

Certain aspects of the present disclosure provide techniques for narrative creation. A method generally includes receiving a selection of a first narrative type for generation, obtaining: a plurality of user responses to a plurality of prompts associated with the first narrative type; and at least one of: one or more stories from one or more users stored in a repository; or one or more insights associated with one or more documents stored in the repository, and processing, by one or more machine learning (ML) models, the plurality of user responses and at least one of the one or more stories or the one or more insights to generate an output associated with the first narrative type.

### CROSS-REFERENCE TO RELATED APPLICATIONS

This Application claims the benefit of and priority to U.S. Provisional Patent Application No. 63/546,729, filed on Oct. 31, 2023, the entire contents of which are hereby incorporated by reference.

### BACKGROUND

### Technical Field

Embodiments of the present disclosure relate to techniques for automated narrative creation.

### Description of Related Art

In the past decade, there has been a remarkable rise and widespread adoption of artificial intelligence (AI) to perform tasks across various domains. From finance and retail to manufacturing and healthcare, AI is a powerful tool enabling, for example, the automation of processes and/or the optimization of operations, to name a few.

Recently, there has been some integration of AI tools into the writing process, such as for narrative creation, also referred to herein as “storytelling” or “data storytelling.” A “narrative” is a fictional or non-fictional story, created and/or assembled for achieving a particular purpose. “Narrative creation” refers to the process of crafting a narrative that conveys information in a way that captures audience attention, enhances understanding, and, in some cases, simplifies complex concepts. Narrative creation may entail the integration of different aspects, such as data analysis and visualization techniques with storytelling principles, to create effective narratives that engage with, influence, and/or inform a particular audience. These aspects pose significant demands for manual (e.g., human-based) narrative creation, especially when 1) dealing with large, complex, and/or dynamic datasets and 2) producing different narratives for different audiences. Moreover, creating compelling narratives is a technically challenging task that requires a diverse skill set, from data analysis to graphic design, creativity, logical consideration, and a keen awareness of the audience and the context. AI tools help to overcome such technical challenges by automatically generating narratives based on human inputs, such as settings, locations, goals, statistics, and/or other types of input.

### SUMMARY

One embodiment of the present disclosure comprises a method (e.g., a computer-implemented method) for narrative creation. The method comprises receiving a selection of a first narrative type for generation, obtaining: a plurality of user responses to a plurality of prompts associated with the first narrative type; and at least one of: one or more stories from one or more users stored in a repository; or one or more insights associated with one or more documents stored in the repository, and processing, by one or more machine learning (ML) models, the plurality of user responses and at least one of the one or more stories or the one or more insights to generate an output associated with the first narrative type.

Another embodiment of the present disclosure comprises a processing system for narrative creation. The processing system comprises a memory comprising computer-executable instructions; and a processor configured to execute the computer-executable instructions and cause the processing system to: receive a selection of a first content type among a plurality of content types for generation; obtain at least one of: a plurality of user responses to a plurality of questions associated with the first content type; one or more stories from one or more users stored in a repository; or one or more insights associated with one or documents stored in the repository; and process, by one or more machine learning (ML) models, at least one of the plurality of user responses, the one or more stories, or the one or more insights to generate an output associated with the first content type.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### DESCRIPTION OF THE DRAWINGS

For a more complete understanding of the present disclosure, reference is now made to the following descriptions taken in conjunction with the accompanying drawings, in which:

FIG. 1A illustrates an example narrative creation system under the present disclosure;

FIG. 1B illustrates an example end-to-end workflow for narrative creation under the present disclosure;

FIGS. 2A-2F illustrate an example user interface for interacting with a story infuser under the present disclosure;

FIG. 3 illustrates an example user interface for receiving user-provided narrative type selection(s) under the present disclosure;

FIG. 4 illustrates an example user interface for receiving user input to a plurality of prompts under the present disclosure;

FIG. 5 illustrates an example user interface displaying a generated narrative under the present disclosure;

FIG. 6 illustrates an example user interface displaying another example narrative generated at least based on a previously-created narrative under the present disclosure;

FIG. 7 illustrates an example narrative structure under the present disclosure;

FIG. 8 illustrates another example narrative structure under the present disclosure;

FIG. 9 illustrates another example narrative structure under the present disclosure;

FIG. 10 illustrates another example of a narrative structure under the present disclosure;

FIG. 11 illustrates example frameworks, patterns, and/or techniques to use for narrative creation under the present disclosure;

FIG. 12 illustrates another example narrative structure under the present disclosure;

FIG. 13 illustrates another example narrative structure under the present disclosure;

FIG. 14 illustrates another example narrative structure under the present disclosure;

FIG. 15 illustrates an example user interface combining frameworks and patterns under the present disclosure;

FIG. 16 illustrates an example computing device under the present disclosure;

FIG. 17 illustrates example training and inference pipelines for machine learning (ML) under the present disclosure;

FIG. 18 illustrates an example neural network under the present disclosure;

FIG. 19 illustrates an example method for narrative creation under the present disclosure;

FIG. 20 illustrates an example method for creating one or more business documents under the present disclosure;

FIG. 21 illustrates an example method for optimizing narrative structure of one or more business documents under the present disclosure; and

FIG. 22 illustrates an example method for obtaining identified business document outcomes.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

The use of AI techniques, such as machine learning (ML), for narrative creation helps to assist humans in efficiently turning information (e.g., data, insights, knowledge, etc.) into compelling narratives. For example, AI-based systems may automate and streamline the process of narrative creation to produce narratives at an expedient pace, significantly reducing the time and/or human resources needed to manually produce similar outputs. For example, based on human input, these systems may generate complete narratives quickly, and in some cases almost immediately, providing a solution for humans, for example, with a limited timeline, struggling with writer's block, and/or lacking the skill level required to produce the output. AI-based systems may also be adaptable to various content formats, thereby allowing for scalability.

Beyond automation, AI-based systems may additionally help to augment human creativity for narrative creation. For example, AI tools may assist users by suggesting plotlines, creating characters, and/or generating dialogue, as well as, in some cases, suggesting ways to represent information that a user may not have previously considered. As such, a user may instead focus their efforts on adding human insight and/or refining a generated narrative. Thus, AI-based systems may enhance the narrative creation, from raw data to engaging stories that resonate with audiences.

Although a powerful tool in the writing process, AI-based narrative creation systems rely heavily on user input, and thus require a large effort from users to gather necessary data, identify valuable insights from the data, and provide this data as input into such systems, in a format that is understandable by these systems. In some cases, the amount of data needed to produce a cohesive and engaging narrative may be substantial and thus, may require heavy lifting on the part of the user.

For example, prior to using an AI-based narrative creation system to generate an article (e.g., an example narrative), a user may spend multiple days researching a topic, gathering relevant documents, obtaining feedback from one or more users or groups, identifying, extracting, summarizing, and/or simplifying insights from the gathered information and feedback, and transforming this information such that it can be provided as input into an AI-based narrative creation system. Not only is this cumbersome and time-consuming for a user, but, best intentions aside, a user may fail to obtain all necessary insights needed to produce a cohesive and engaging narrative. As such, a narrative produced by the AI-based creation system may lack important detail, provide inaccurate artifacts, and/or fail to engage its intended audience, which are resulting technical problems of conventional AI-based narrative creation systems.

Accordingly, conventional techniques are not efficient or effective for narrative creation.

Embodiments described herein overcome the aforementioned technical problems associated with some conventional techniques, and provide a technical benefit to the field of content generation. Specifically, embodiments described herein provide a flexible end-to-end workflow (simply referred to herein as “workflow”) for creating a variety of narratives. For example, certain embodiments focus on using the workflow for crafting non-fiction outputs, such as white papers, one page summaries, marketing materials, business documents, and the like. Certain embodiments also provide an ability to automatically convert narratives from one format to another (such as converting a white paper to a presentation).

The workflow described herein may encompass various aspects of narrative creation by integrating specific methodologies, models, and/or technologies to provide a comprehensive and consistent framework for creating cohesive, accurate, and effective narratives that engage with, influence, and/or inform a particular audience. For example, the workflow may combine techniques for (1) identifying relevant documents, such as articles, for analysis, (2) acquiring story (ies) from one or more contributors, (3) obtaining specific user input, (4) identifying valuable insights from documents, stories, and/or user-provided input, and (5) leveraging these insights to generate output(s) associated with one or more narrative types.

In certain embodiments, the workflow may utilize natural language processing (NLP) and ML techniques to identify and analyze relevant documents, such as for creating “document insights.” As used herein, NLP is an ML technology that gives computers the ability to interpret, manipulate, and comprehend human language. For example, one or more queries may be generated based on a particular narrative type. A semantic search engine, utilizing NLP and ML techniques, may be implemented to process the query (ies), such as to execute searches across one or more databases to identify and retrieve document(s) that may be useful for creating the particular narrative type. The semantic search engine may employ semantic similarity scoring and ranking to identify a subset of documents, among the database(s), that are most relevant to the creation of the particular narrative type. The workflow may further leverage one or more language models (LMs) to perform sentiment analysis (e.g., determining the sentiment expressed in a piece of text) and text summarization (e.g., condensing a long piece of text into a shorter summary) for the subset of documents, such as to extract and summarize insights from the subset of documents. These insights may be stored in an information repository for future use in generating narratives of the particular narrative type.

As used herein, a LM is generally a type of ML model that is designed to understand, generate, and manipulate human language. Specifically, a LM is a sophisticated NLP tool that analyzes and generates human language by understanding the probabilistic relationships between tokens (e.g., tokens may be units of text that the LM processes and generates, such as individual characters, words, subwords, or even larger linguistic units) and leveraging large datasets to learn these relationships. LMs form the backbone of many modern NLP applications, enabling machines to interpret, generate, and interact with human language. LMs are sometimes distinguished as between a “large” LM (LLM) and a “small” LM (SLM) based on the size and complexity of the model, which affects their capabilities and applications. For example, LLMs are often characterized by their large number of parameters, ranging from hundreds of millions to trillions of parameters.

In certain embodiments, the workflow may utilize an AI-powered story infuser (simply referred to herein as a “story infuser”) to automatically collect one or more types of stories from contributors, which may be subsequently used for narrative creation. As used herein, a “story” may be any structured or unstructured sequence of data, concepts, events, or experiences, communicated through diverse mediums, technologies, or formats, to convey meaning, emotion, or knowledge. Stories may be short-form or long-form, and may exist across various formats. Stories may serve a variety of purposes, including but not limited to education, communication, persuasion, and/or branding. Stories may be designed to elicit cognitive, emotional, and/or behavioral responses from audiences, and, in some cases, may be targeted for a specific audience. Example stories may include stories about overcoming challenges (e.g. “challenge stories”), testimonials related to a person, product, and/or service, patient stories, opinions, technical insights and/or the like.

For example, the story infuser may enable a user to tailor a predefined set of prompts and/or craft a new set of prompts to obtain specific information from one or more contributors to generate stories. In certain embodiments, the story infuser may use AI to generate a set of contributor-facing prompts, such as based on a list of questions provided and/or selected by the user. The story infuser may generate story requests prompting contributor(s) to respond to the set of prompts, and send out the story requests to the contributor(s), for example, via email, quick response (QR) code, or a shareable link, among other options. Contributor(s) may share their experience(s), such as based on providing answers to the sets of prompts via a user interface. In certain embodiments, a contributor's response may be stored in an information repository as one or more stories without further processing. In certain other embodiments, one or more LMs may be used to extract and summarize the contributor's response into one or more stories that may be stored in an information repository. In certain embodiments, the story infuser may use AI to adjust the tone, length, etc. of a generated story, such as based on one or more preferences of the user. The generated stories may be stored for future use in generating various narrative types.

In certain embodiments, the stories and document insights, collectively referred to herein as “information repository entries,” may be stored in a graph in the information repository. For example, the graph may include multiple nodes and edges. Each information repository entry may be represented by a single node in the graph. Nodes may be connected by edges which represent the relationships between the different information repository entries. The information repository entries may be stored in such a manner to allow for the utilization of graph-based retrieval-augmented generation (RAG).

Graph-based RAG is an advanced framework that combines the retrieval of knowledge with text generation, helping to enhance the quality and accuracy of generated content by pulling in relevant context from an external knowledge base. In a technical sense, graph-based RAG may apply graph theory to model relationships between data points in the information repository (e.g., example knowledge base), and leverage these relationships to retrieve the most relevant information before generating text.

The workflow described herein may utilize graph-based RAG to identify nodes that are most relevant to the generation of a particular narrative type. For example, a user may provide an input query requesting to generate a particular narrative type based on some user-provided input. The graph-based RAG may be configured to identify one or more nodes, each associated with a respective information repository entry that are relevant to the user's input query. Graph-based RAG may be used to retrieve these information repository entry (ies) associated with these node(s), which may be subsequently leveraged to generate the user-selected narrative type. In certain embodiments, the retrieved information repository entry (ies) may be used in combination with the user-provided input to generate a cohesive narrative associated with the selected narrative type. Although embodiments herein are described with respect to the use of graph-based RAG, in certain other embodiments, other retrieval engines, such as traditional RAG, may be considered and used to perform similar functions.

For example, in certain embodiments, the workflow may utilize generative AI models, such as one or more LMs, to analyze user-provided input and/or retrieved information repository entry (ies) to produce coherent and contextually appropriate text for a selected narrative type. That is, the LMs may be utilized to process this information and generate a specific type of narrative.

The integration of end-to-end methodologies, models, and/or technologies in the workflow beneficially offers a robust approach to narrative creation that addresses technical problems associated with conventional AI-based systems for generating narratives, as described above. Specifically, the workflow obtains valuable information insights from various users, sources, and/or contributors to generate cohesive, accurate, empathetic, and effective narratives that engage with, influence, and/or inform a particular audience. As such, the workflow overcomes technical problems associated with conventional AI-based approaches for narrative creation that rely on a user to provide, as input, the necessary artifacts for generating a narrative. By instead relying on integrated methodologies, models, and/or technologies, the workflow provides a streamlined and analytical approach to identify relevant and valuable insights, from a knowledge base, and use these insights for creating one or more types of narratives for various audiences. Accordingly, the workflow beneficially is an efficient, consistent, and repeatable workflow that improves upon the state of the art.

Use of one or more LMs for narrative creation also provides further technical benefits. Specifically, LMs have proven to be powerful tools in summarizing lengthy text context, extracting key information, and providing concise summaries. This is particularly due to their transformer architecture (e.g., architecture that uses an encoder-decoder structure and does not rely on recurrence and/or convolutions to generate an output) and use of attention mechanisms to focus on relevant parts of text when generating outputs (e.g., summaries). The attention mechanisms allow an LM to assign different weights to different tokens in the text, enabling the LM to capture long-range dependencies and contextually relevant information, such as for information extraction and/or narrative creation. Further, LMs make it possible for software to “understand” typical human speech or written content, such that this information can be utilized for efficiently generating more comprehensive and accurate narratives.

Furthermore, certain embodiments described herein allow for narrative outputs (e.g., articles, white papers, etc.) to integrate narrative structures that have been shown to be most effective for conveying the desired results.

### Example Narrative Creation System

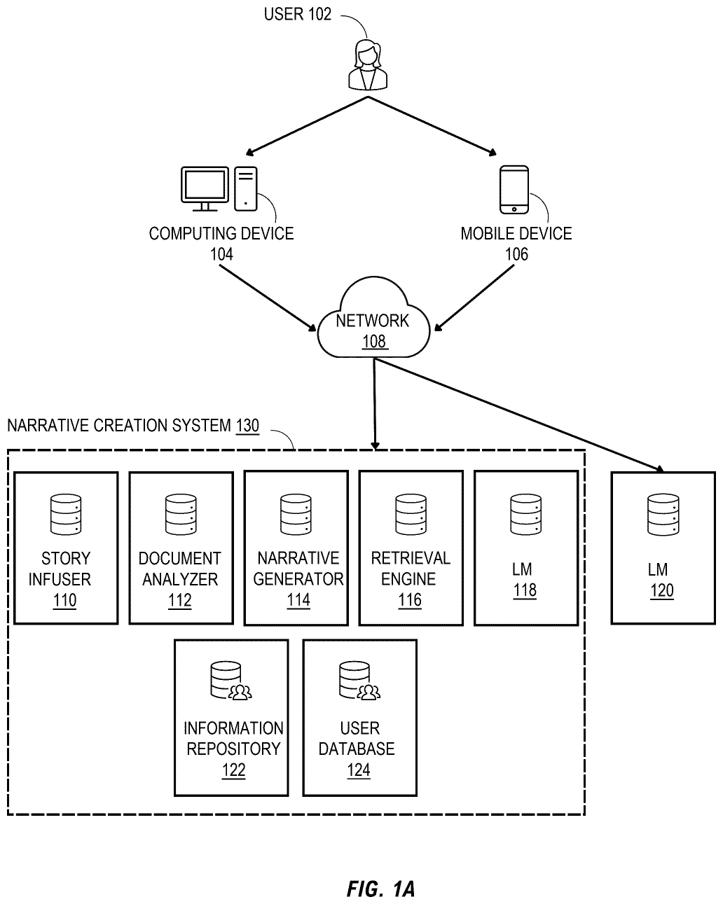

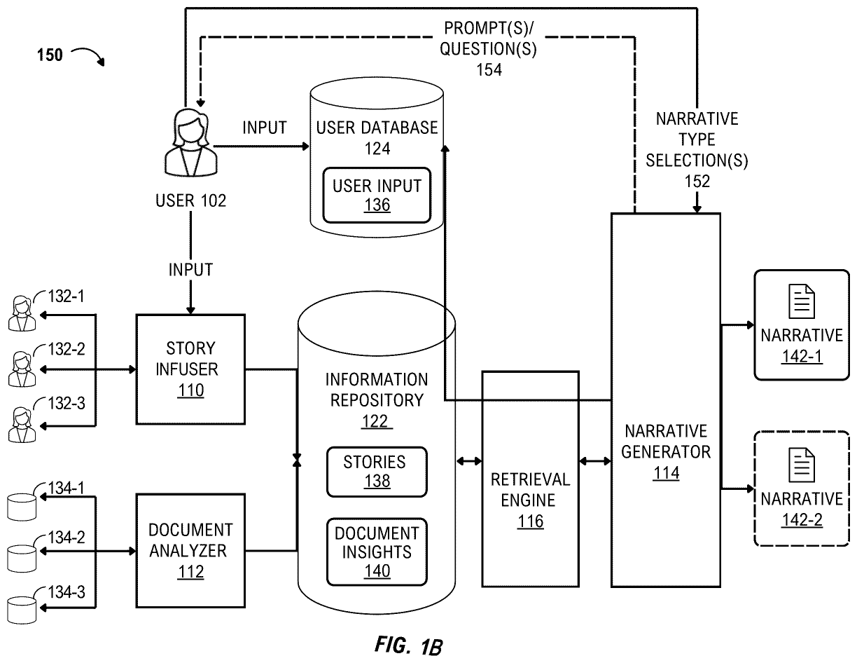

FIG. 1A illustrates an example narrative creation system 130. As shown in FIG. 1A, a user 102 may use a computing device 104 and/or a mobile device 106 (e.g., which may each comprise a variety of computing devices or smart devices, such as laptop(s), tablet(s), smartphone(s), etc.) to connect via a network 108 (e.g., the Internet, an enterprise network, cellular network, etc. or a combination of the foregoing) to a narrative creative system 130. Although FIG. 1A illustrates only a single user 102 connected to narrative creation system 130, in certain embodiments, multiple users may connect to narrative creation system 130.

Narrative creation system 130 may implement an end-to-end workflow for narrative creation. For example, narrative creation system 130 may include one or more servers comprising a story infuser 110, a document analyzer 112, a narrative generator 114, a retrieval engine 116, one or more LMs 118 (e.g., LLM(s)), an information repository 122, and a user database 124, containing at least data input by user 102, to generate one or more narratives. In certain embodiments, “information repository 122” may be simply referred to herein as “repository 122.” In certain embodiments, one or more components of narrative creation system 130 may be remotely located or provided by a third party. For example, third party (or remote) LM 120 may optionally be used by narrative creation system 130 instead of local LM(s) 118. Further, in certain embodiments, although not shown in FIG. 1, a single server or computing device may provide the functionality described with respect to narrative creation system 130, with story infuser 110, document analyzer 112, narrative generator 114, retrieval engine 116, LM(s) 118, information repository 122, and user database 124 representing modules within said server(s)/computing device(s).

FIG. 1B illustrates an example end-to-end workflow 150 for narrative creation, which may be performed by narrative creation system 130 in FIG. 1A. More specifically, workflow 150 may be performed by narrative creation system 130 to generate one or more narratives 142 (e.g., shown as narrative 142-1 and narrative 142-2 in FIG. 1B) based on, at least, one or more narrative type selection(s) provided by user 102. For example, based on a user 102 requesting to create a white paper (e.g., an example narrative type selection), narrative creation system 1300 may generate narrative 142-1, which is an example white paper. Workflow 150 describes the type of inputs used to create narrative(s) 142 and how those inputs are retrieved and/or processed by components of narrative creation system 130.

To generate one or more narratives 142, workflow 150 begins with obtaining user input from user 102. For example, narrative creation system 130 may provide user 102 with a user interface on computing device 104 and/or mobile device 106 (not shown in FIG. 1B). The user interface may allow the user 102 to provide a selection of one or more narrative types 152 that user 102 is requesting narrative creation system 130 to generate. For example, in certain embodiments, the user may provide, via the user interface, a short summary of a desired output/narrative type (e.g., a white paper about copper costs in Europe, a 1 pager about a company's telecommunications services available in the Pacific Northwest, etc.). As another example, in certain embodiments, the user 102 may be provided with a list of narratives that may be generated, and the user may select one or more of the listed narratives. Example narratives that may be created by narrative creation system 130 may include a pitch, a value proposition, a problem statement, an impact statement, a solution statement, a business case statement, a pitch deck, a summary, a simplified version, a bottom line up front (BLUF), an article, a one-pager, a case study (e.g., standalone), a white paper, a press release of the future (e.g., an innovation story), a thought leadership article: problem-solution, a patient story article, a thought leadership article: technology insights article, a challenge story, a testimonial, a social media post, an elevator pitch, a research (e.g., detailed technical) report, a thought leadership Article: how to article, a thought leadership article: an opposite-the editorial (op-ed) article, a thought Leadership article: paradigm shift, a thought leadership article: perspectives/commentary article, a video script, an executive summary transformation, a presentation (e.g., a general-purpose presentation), a slide deck, a research and development presentation, a product demos, a product overviews presentation, a sustainability presentation, a corporate social responsibility (CSR) initiatives presentation, a regulatory and compliance training presentation, a strategy and key objectives presentation, a meeting with the board presentation, a corporate deck, a business strategy presentation, a technical demonstrations presentation, investor and/or stakeholder update(s), training and educational Material, a sales and marketing pitch, a project status report, pitch transformations (e.g., timing, length, etc.), a project status report (e.g., during a project), a project report (e.g., close out), a project plan, a product requirements document (PRD), user stories, a project update generator (e.g., transform of report, less formal), an innovation story based on a Breaking Through at Last pattern, an innovation story based on a Discovering Happy Accidents pattern, an innovation story such as an origin story, an innovation story based on a Solving the Problem pattern, an innovation story such as a failure story, an invention disclosure (e.g., internal to a company, which may be confidential), an innovation story such as a project pre-mortem story, an after action review (e.g., project post-mortem), epics (e.g. product use cases), acceptance criteria (e.g., product use cases), an explainer video script, and/or product technical specifications (e.g., a mini-PRD), among others. Example presentations may include presentations for a product demonstration; a sales enablement; a marketing plan; and/or an innovation pitch, among others. It should be noted that the list of narratives are only example narratives that may be created by narrative creative system 130 according to workflow 150. In other words, the example narratives listed are not an exhaustive list, and workflow 150 may be applied to create one or more other types of narratives not listed herein.

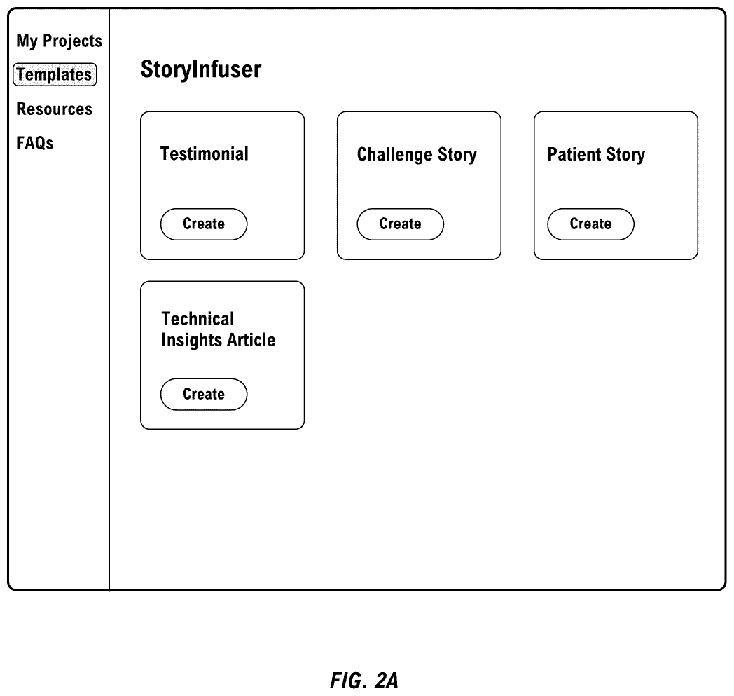

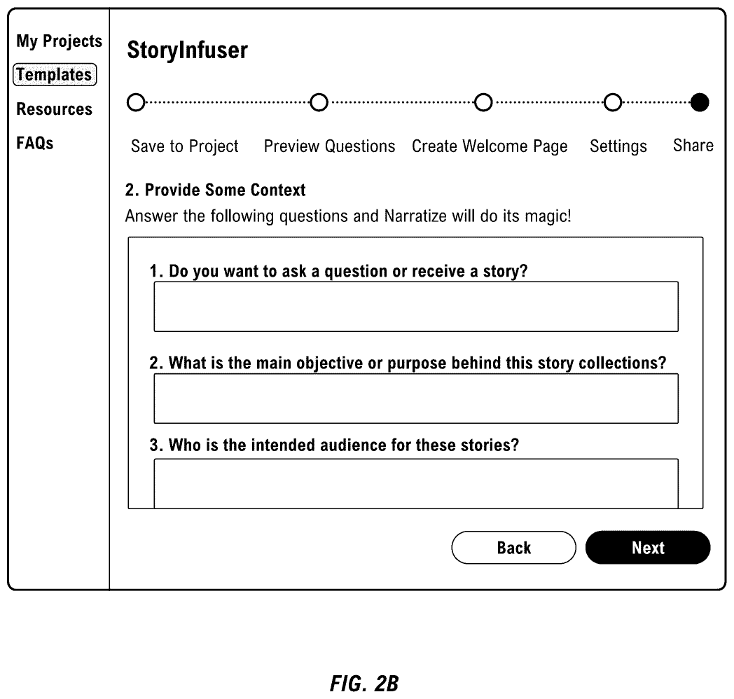

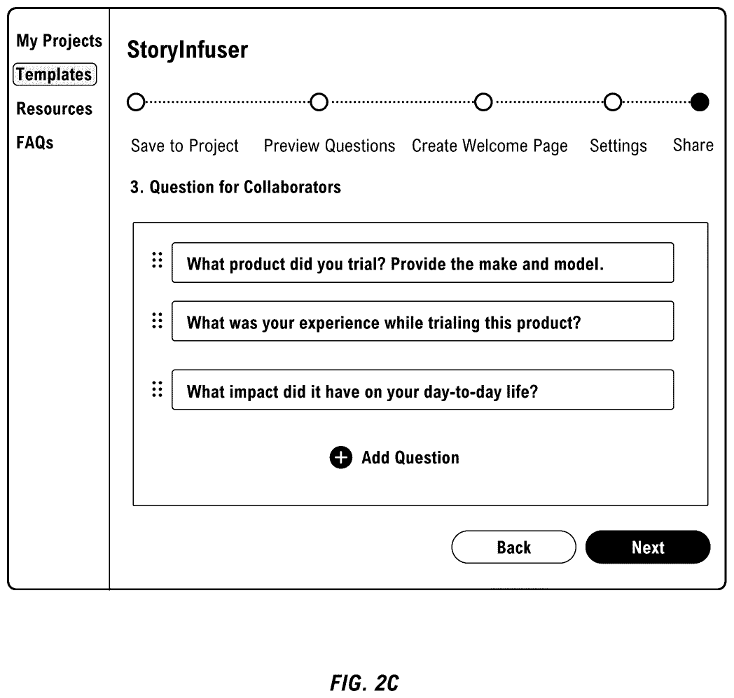

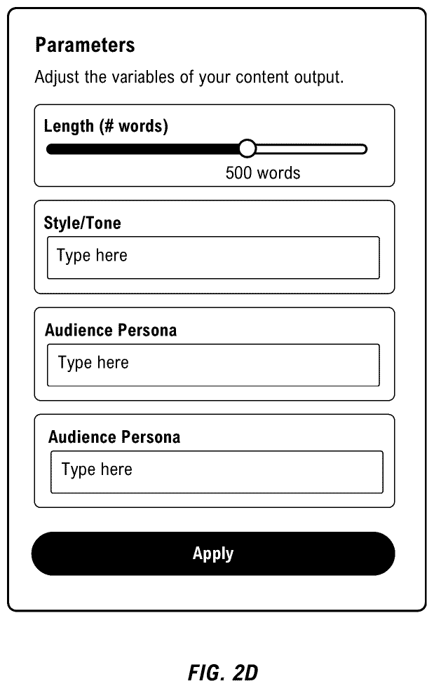

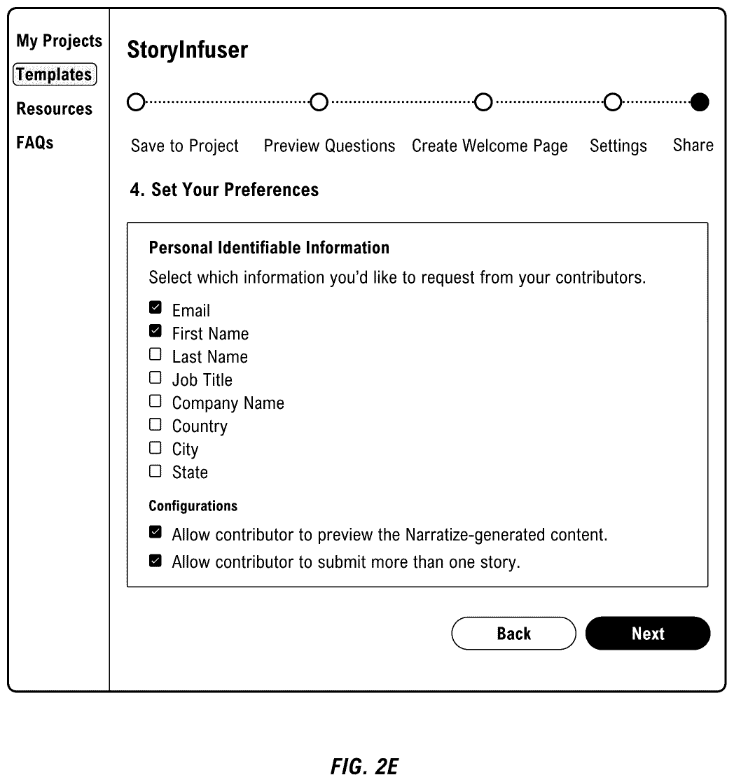

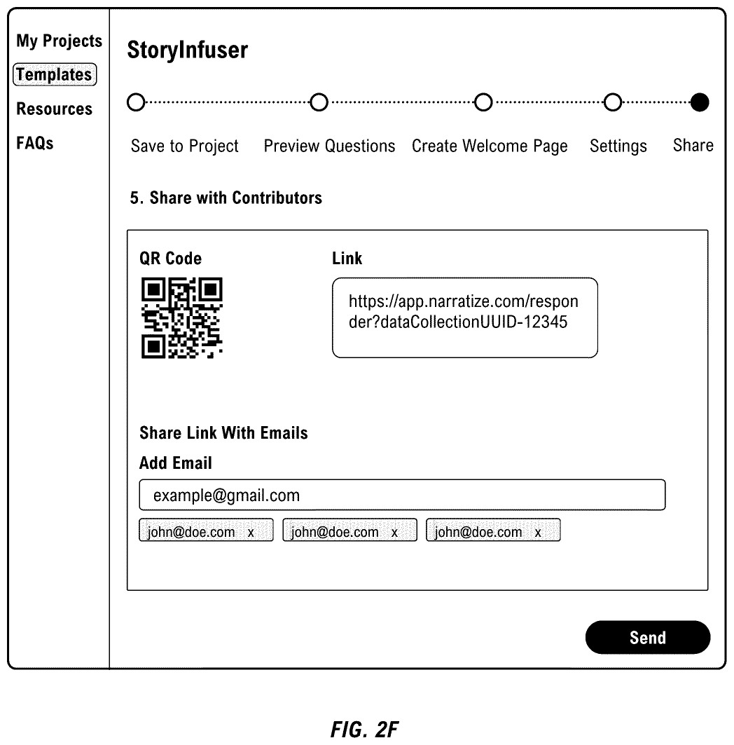

An example user interface providing example narratives for user selection is depicted and described below with respect to FIG. 2A.

In addition to providing narrative type selection(s), the user 102 may use the user interface to input a variety of information, such as answer(s) to one or more prompts and/or questions 154 or other data useful or necessary for the creation of the desired output (e.g., the desired narrative type). This information may be stored (e.g., temporarily, semi-temporarily, permanently) as user input 136 in user database 124. Additionally, in certain embodiments, the user 102 may create their own custom templates and/or workflows based on questions and answers, existing templates, and examples. Creating a custom workflow may include creating a custom template by uploading existing template(s), uploading example(s) of final document(s), and/or explaining a document. The narrative creation system may then suggest one or more prompts that should be asked in order to produce that type of narrative output again and again.

Narrative generator 114 may determine a type and/or number of narratives 142 to generate based on narrative type selection(s) 152. For example, if user 102 requests to generate a white paper and a presentation, then narrative generator 114 may generate a first narrative 142-1 as a white paper and a second narrative 142-2 as a presentation. Narrative generator 114 may analyze user input 136, in user database 45, to generate the narrative(s) 142 associated with the narrative type selection(s).

In certain embodiments, narrative generator 114 may use one or more LMs, such as LM 118 and/or LM 120 shown in FIG. 1A, to analyze user provided input and produce coherent and contextually appropriate text for narrative type selection(s) 152.

In certain embodiments, the one or more LMs used by narrative generator 114 may include a variety of LLMs. Generally, LLMs are characterized by their large size. LLM 55 may comprise AI accelerators able to process large amounts of data and text, which may be downloaded or scraped from outside sources, such as the Internet. LLMs comprise artificial neural networks which can contain millions (or more) of weights, and are trained using ML techniques, such as self-supervised learning or semi-supervised learning. LLMs can comprise a variety of functionalities, but often function by ingesting text and attempting to predict the next token or word. Some LLM embodiments require fine tuning to adapt a model to accomplish specific tasks. Other larger embodiments, such as GPT-4, can be prompt-engineered to achieve similar functionality or results. Preferred embodiments of the present disclosure comprise LLMs such as GPT-4, but other embodiments are possible. For example, narrative generator 114 and narrative creation system 130 may be compatible with a variety of LLMs, such as GPT-3, Clause 3.5 Sonnet, etc. Further, narrative generator 114 may be LLM-agnostic.

Further, in certain embodiments, narrative generator 114 may retrieve and utilize one or more stories 138 and/or one or more document insights 140, stored in information repository 122, for generating narrative(s) 142. For example, narrative generator 114 may use a retrieval engine 116 to identify one or more stories 138 and/or one or more document insights 140 that may be relevant and useful when generating narrative(s) 142 requested by user 102, and further use these identified story (ies) 138 and/or document insight(s) 140, in addition to user input 136, to generate narrative(s) 142.

In certain embodiments, retrieval engine 116 may process the user input 136 (and, in some cases, narrative type selection(s) 152) from user 102 and retrieve one or more stories 138 and/or one or more document insights 140 from information repository 122. In certain embodiments, the retrieval engine 116 may employ one or more algorithms to identify which of the stories 138 and/or document insights 140 from information repository 122 are related to user input 136. For example, retrieval engine 116 may utilize methods such as (1) semantic search techniques to understand the meaning and context of the user input 136, the stories 138, and/or the document insights 140 and/or (2) techniques to rank and prioritize related content received from the information repository 122.

In certain embodiments, retrieval engine 116 is an example graph-based RAG. That is, stories 138 and document insights 140 may be stored in information repository 122 as nodes of a graph. More specifically, each node may be associated with a single story 138 or a document insight 140. The nodes may be connected by edges, which represent the relationships between the different pieces of knowledge. The retrieval engine 116, e.g., the example graph-based RAG, may (1) process user input 136, (2) generate a respective relatedness score for each node (e.g., based on its corresponding story 138 or document insight 140) indicating a respective relatedness of the respective node (or its corresponding story 138 or document insight 140) to user input 136, (3) rank the nodes based on their relatedness scores, and (4) identify a top-k subset of nodes (e.g., where k is an integer greater than one) based on the ranking and/or a subset of nodes having a relatedness score higher than a threshold relatedness score. Story (ies) 138 and/or document insight(s) 140 corresponding to the identified subset of node(s) may be passed to narrative generator 114 and used by narrative generator 114, in addition to user input 136, to generate narrative(s) 142.

The graph structure of stories 138 and document insights 140 in information repository 122 helps to enable narrative creation system 130 to explore multiple relevant connections between stories 138 and/or document insights 140. For instance, if user input 136 relates to a first topic, such as “surgery,” retrieval engine 116 may identify that a first node, including a first story 138, is related to the first topic, and further identify that a second node, including a first document insight 140, is also related to the first topic based on the first node and the second node (e.g., the first story 138 and the first document insight 140) being related (e.g., having an edge connecting the two nodes). In certain embodiments, retrieval engine 116 may filter out nodes associated with stories 138 and/or document insights 140 that are unrelated to user input 136 based on these nodes being farther away from user input 136 (e.g., provided as an input query) in terms of graph proximity.

As an illustrative example, information repository 122 may include four stories 138. A first story 138 may comprise a testimonial about a surgeon. A second story 138 may comprise a testimonial about a prescription drug. A third story 138 may comprise a challenge story related to a surgery performed. A fourth story 138 may comprise a technical insight about a new medical device. Although in this example, information repository 122 includes only four stories 138, in certain other examples, information repository 122 may include more or less stories 138 and/or one or more document insights 140.

Each of these four stories 138 may be represented as nodes in a graph in information repository 122. The nodes may be connected by edges, which represent the relationships between the four stories 138. For instance, the first story 138, e.g., the testimonial about a surgeon, may have a strong relationship with the third story 138, e.g., the challenge story related to a surgery performed, as they are both related to surgery. Thus, a first edge, in the graph, may connect the node associated with the first story 138 and the node associated with the third story 138. Further, a second edge may connect a node associated with the second story 138, e.g., the testimonial about the prescription drug, and a node associated with the fourth story 138, e.g., the technical insight about medical device, based on the medical device being be a device used in the same treatment protocol associated with the prescription drug.

In this example, user 102 may request that narrative creation system 130 generate a narrative 142 as a presentation about a recent medical case involving surgery. In response, user 102 may be provided with multiple prompts related to the medical case. Responses to these prompts may be provided by user 102 and stored as user input 136 in user database 124.

Retrieval engine 116 may obtain and analyze language of user input 136. For example, based on its analysis, retrieval engine 116 may determine that user input 136 is related to topics such as “surgery,” “challenges,” and “medical devices.” Retrieval engine 116 may then process the four stories 138 included in information repository 122 to identify which stories 138, if any, are related to “surgery,” “challenges,” and/or “medical devices.” In other words, retrieval engine 116 may traverse the four nodes in the graph created for information repository to check for relationships, if any, between user inputs 136 and each of the four stories 138 (e.g., each represented as a node).

In certain embodiments, retrieval engine 116 may generate a relatedness score for each node in the graph. For example, retrieval engine 116 may generate a first relatedness score for a node associated with the first story 138 (e.g., a testimonial about a surgeon) indicating a relatedness of the first story to user input 136. Similarly, retrieval engine 116 may generate a second relatedness score for the node associated with the second story 138, a third relatedness score for the node associated with the third story 138, and a fourth relatedness score for the node associated with the fourth story 138. In certain embodiments, retrieval engine 116 may rank the nodes based on their relatedness scores (e.g., a node associated with a highest relevance score may be ranked first). In certain embodiments, retrieval engine 116 may determine that the top-k nodes in the rank are related to user input 136. For example, retrieval engine 116 may determine that the top two nodes, with the highest relatedness scores, are related to user input 136. In certain other embodiments, retrieval engine 116 may determine that a node is related to user input 136 based on the respective relatedness score for the node being above a relatedness score threshold.

In this example, retrieval engine 116 may determine that three nodes, and more specifically, three of the four stories, are related to user input 136. For example, retrieval engine may determine that the node associated with the first story 138 (e.g., a testimonial about a surgeon), the node associated with the third story 138 (e.g., a challenge story related to a surgery performed), and the node associated with the fourth story 138 (e.g., a technical insight about a new medical device) are all related to user input 136 (e.g., a recent medical case involving surgery). For example, retrieval engine 116 may determine that the node associated with the fourth story 138 is related based on user input 136 mentioning a similar/related device used in the surgery. As another example, retrieval engine 116 may determine that the node associated with the first story 138 is related based on user input 136 mentioning the specific surgeon mentioned in the first story 138.

Retrieval engine 116 may provide, to narrative generator 114, the stories 138 and/or document insights 140 determined to be related to user input 136. Narrative generators may generate narrative(s) 142 based on user input 136, narrative type selection(s) 152, related stories 138 provided to narrative generator 114, and/or related document insights 140 provided to narrative generator 114.

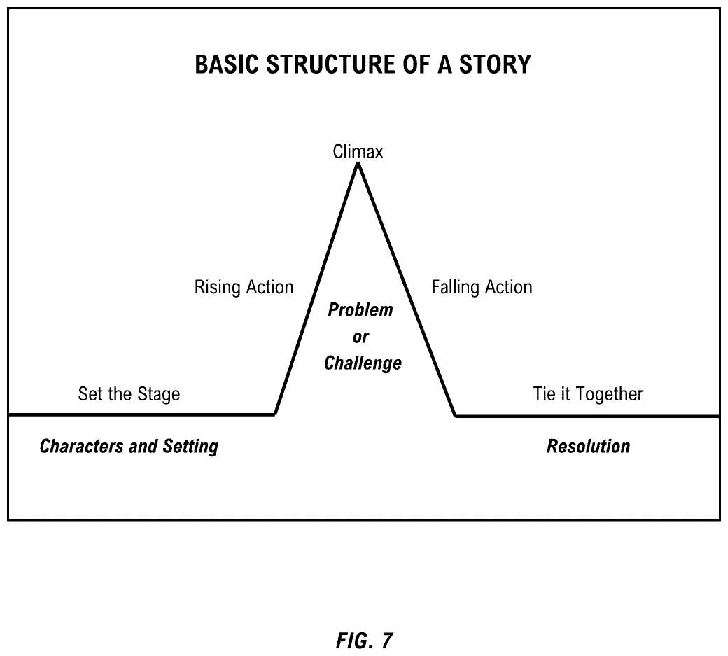

In certain embodiments, narrative generator 114 utilizes one or more ML models to generate a narrative 142. In certain embodiments, the ML model(s) may be used to generate a narrative 142 according one or more frameworks, one or more patterns, and/or one or more techniques. Example frameworks, patterns, and techniques that may be used are depicted and described below with respect to FIGS. 7-15.

After generating narrative(s) 142, narrative creation system 130 provides as output, such as to user 102, the narrative(s) 142. For example, narrative creation system 130 may display the generated narrative(s) on a user interface of computing device 104 and/or mobile device 106, shown in FIG. 1A, for viewing by user 102. User 102 may utilize the generated narrative(s) for various purposes, including, for example, in marketing materials, when pitching a product to a client, in a paper submission for a journal, when presenting to a large audience, and/or the like.

As discussed above, information repository 122 may include stories 138. In certain embodiments, a story infuser 110 may be used to add stories 138 to information repository 122. Story infuser 110 may enable user 102 to automatically collect responses from one or more contributors 132-1 through 132-3 (collectively referred to herein as “contributors 132” and individually referred to herein as “contributor 132”) to generate stories 138. The stories generated based on responses from contributors 132 may be stored in information repository 122 and subsequently used by narrative generator 114 of creating one or more narratives 142. FIGS. 2A-2F illustrate an example user interface for interacting with a story infuser to generate stories based on responses from one or more contributors. For example, user 102 may interact with the example user interface shown in FIGS. 2A-2F to obtain stories 138 from contributors 132-1, 132-2, 132-3 shown in FIG. 1B.

As shown in FIG. 2A, to begin using story infuser 110, a user may be prompted to select one or more types of stories to generate. Example types of stories that may be generated based on contributor response include testimonials, challenge stories, patient stories, and/or technical insights, among others. The user may select one or more of the types of stories and/or specify one or more other types of stories (e.g., custom stories) the user desires to generate and store in an information repository.

As shown in FIG. 2B, after identifying the type(s) of stories to generate, the user may be prompted to provide some additional context. The additional context may be used by the story infuser to generate a plurality of questions and/or prompts that may be sent to contributors. As shown in FIG. 2C, the story infuser may display, to the user, the generated one or more prompts and/or questions that may be provided to contributors. The user may accept the provided prompts and/or questions and/or revise/supplement the provided prompts and/or questions.

In certain embodiments, the questions and/or prompts may help contributors think further and/or differently about the information they provide in their responses. In certain embodiments, the questions and/or prompts may help to instruct contributors to provide responses for a particular purpose, for a particular audience, for a particular product/service, and/or with a particular format. In certain embodiments, the questions and/or prompts may be used to guide the contributors in their responses.

Subsequently, as shown in FIG. 2D, the user may be prompted to specify one or more parameters for the stories generated based on contributor responses. Example parameters specified by the user may include story length (e.g., a number of words, a number of pages, etc.), story style, story tone, the type of audience (e.g., leadership, technical, marketing, general audiences, executives, operations, etc.) for the story, the size of the audience (e.g., number of people) for the story, a story format (e.g., bulleted list, report, document, one-pager, presentation etc.), a story medium (e.g., email, print, poster, etc.), a venue for the story (e.g., a business, a meeting, a conference, etc.), and/or the like.

As shown in FIG. 2E, the user may then be prompted to specify one or more preferences. For example, the user may specify the type of information that may be gathered from each contributor. The information gathered from a contributor may include the contributor's first name, last name, job title, company, country, city, state, and/or the like. In certain embodiments, the user may desire that the contributors remain anonymous; thus, the user may specify that no additional information is to be collected from the contributors. As another example, the user may specify whether, or not, the contributor may view the story (ies) generated by the story infuser based on the contributor's answers. As another example, the user may specify whether multiple stories may be created by the story infuser for a single contributor.

After providing the necessary information, a link and/or a QR code may be generated to share with contributors, as shown in FIG. 2E. In certain embodiments, the user may distribute this link and/or QR code to the contributors manually. In certain other embodiments, the user may specify email addresses of the contributors such that the QR code and/or link are automatically sent to each of the contributors via their provided email addresses. When using the link and/or the QR code, the user may be prompted to provide responses to the prompts and/or questions generated and shown in FIG. 2C. The story infuser may generate one or more stories based on the contributor's responses. In certain embodiments, a story created by the story infuser may summarize the contributor's response. In certain embodiments, a story created by the story infuser may compile all of the contributor's responses without further changes and/or formatting. In certain embodiments, a story created by the story infuser may have the contributor's responses aggregated with additional content generated by the story infuser.

In certain embodiments, the story infuser may display story (ies) generated based on a contributor's responses to the contributor.

The story infuser may store each of the generated stories in an information repository, such as information repository 122 shown in FIG. 1B. In certain embodiments, the contributor may need to accept the generated story before it is stored in the information repository. As described above, stories stored in the information repository may be subsequently used for generating one or more narratives.

Returning to FIG. 1B, as discussed above, information repository 122 may also include document insights 140. In certain embodiments, a document analyzer 112 may be used to add document insights 140 to information repository 122. More specifically, document analyzer 112 may be configured to identify and analyze relevant documents (e.g., such as scholarly articles), combining advanced NLP with specialized academic search capabilities.

For example, in certain embodiments, document analyzer 112 may be used to perform single source analysis and analyze a single document to generate one or more insights for the single document. For instance, user 102 may provide a document when providing narrative type selection(s) 152 and user input 136 (uploading the document is not shown in FIG. 1B). As another example, user 102 may provide the document prior to choosing a narrative type (e.g prior to providing narrative type selection(s) 152. User 102 may provide the document based on uploading a digital copy of the document for processing. In some other cases, user 102 may provide the document based on searching for and selecting a single document. The document may be any type of structured or unstructured document. Example documents may include a PDF, a word document, or a text file. In certain embodiments, optical character recognition (OCR) may be performed on the document to generate OCR data for the document that may be used by document analyzer 112.

Document analyzer 112 may obtain the uploaded document and extract key information from the document. More specifically, document analyzer 112 may leverage one or more LMs (e.g., such as one or more LLMs) to perform sentiment analysis (e.g., determining the sentiment expressed in a piece of text) and text summarization (e.g., condensing a long piece of text into a shorter summary) for the document, such as to extract information and generate document insights 140 from the document. In certain embodiments, document analyzer 112 determines the information to extract from the document based on user input 136. In certain embodiments, document analyzer 112 determines the information to extract from the document based on a narrative type selection 152, such that the document insights 140 generated based on the extracted information are useful for generating narratives of the particular narrative type. The generated document insights 140 may be stored in information repository 122.

In certain embodiments, the insights generated and stored in information repository for the document may include a summary; key findings; a simplified version of the document; an impact statement; a situate perspective; a methodology analysis; contextualizing the document; a solution statement; key quotes; identified gaps in teaching; and/or opportunities, among others. Each of the different insights may be associated with a unique prompt. Thus, when a specific insight is to be created for the document, the prompt associated with the specific insight may be provided to the LM(s) to trigger the LM(s) to generate the specific insight for the document. For example, to extract information and create a simplified version of a document, one or more LM(s) may be prompted with a prompt associated with the insight “simplified version of the document.” The prompt may include specific instructions on how to produce the desired output, e.g., the simplified version of the document. Further, the prompt may include specific writing guidelines for producing the desired output. The prompt may also describe the types of text that may be submitted and how to extract within those contexts.

In certain embodiments, the one or more LM(s) performing the single source analysis may include GPT-4 made available by Open AIR®.

In certain other embodiments, document analyzer 112 may be used to perform multi-source analysis. Document analyzer 112 may perform multi-source analysis based on (1) executing searches across one or more databases 134-1, 134-2, 134-3 (collectively referred to herein as “databases 134” and individually referred to herein as “database 134”) to identify and retrieve document(s) that may be useful for creating a particular narrative type and (2) further analyzing these identified documents to generate one or more document insights 140. In certain embodiments, document analyzer 112 may be triggered to perform multi-source analysis based on user 102 providing narrative type selection(s) 152. For example, document analyzer 112 may perform multi-source analysis to (1) identify document(s) that are relevant to the narrative type selection(s) 152 provided by user 102 and (2) generate document insights 140 for the documents. In certain other embodiments, document analyzer 112 may perform multi-source analysis prior to user 102 providing narrative type selection(s) 152. For example, document analyzer 112 may perform multi-source analysis multiple times. For each iteration, document analyzer 112 may (1) identify document(s) that are relevant to a specific narrative type and (2) generate document insights 140 based on the identified documents. Document analyzer 112 may store the generated document insights 140 in information repository 122 for subsequent use in generating the specific narrative type. Although FIG. 1B illustrates document analyzer retrieving documents from three databases 134-1, 134-2, and 134-3, in certain other embodiments, document analyzer 112 may retrieve documents from more or less databases.

In certain embodiments, multi-source analysis includes steps for (1) text preprocessing, (2) query expansion, (3) document retrieval, (4) relatedness score generation and ranking, and (5) content processing. Text preprocessing may include performing lemmatization to reduce words in documents in included in databases 134 to their root form (e.g., transform the token “running” into the token “run”) prior to analyzing any of the documents. Query expansion may include generating one or more queries based on a particular narrative type. For example, a first set of queries may be generated and associated with a first narrative type “summary,” and a second set of queries may be generated and associated with a second narrative type “presentation.” Document retrieval may include executing searches across databases 134 to identify and retrieve document(s) that may be useful for creating a particular narrative type. For example, based on executing the first set of queries, document retrieval may be performed to identify document(s) that may be useful for creating a first narrative type “summary.” In certain embodiments, a semantic search engine, utilizing NLP and ML techniques, may be implemented to process the query (ies), such as to execute the searches across databases 134 to identify and retrieve the document(s). The semantic search engine may employ semantic similarity scoring and ranking to identify a subset of documents, among the databases 134 that are most relevant to the creation of the particular narrative type (e.g., perform relatedness score generation and ranking). Content generation may include using one or more LMs to perform sentiment analysis (e.g., determining the sentiment expressed in a piece of text) and text summarization (e.g., condensing a long piece of text into a shorter summary) for the identified subset of documents, such as to extract information and generate documents insights 140 for the subset of documents. These document insights 140 may be stored in information repository 122 for future use in generating narratives of the particular narrative type.

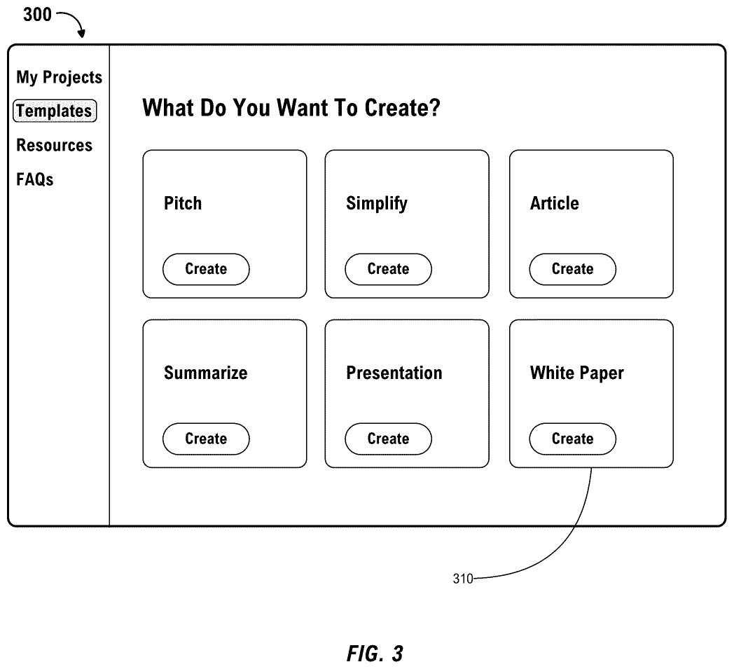

FIG. 3 displays one embodiment of a starting user interface 300 for receiving user input. For example, starting user interface 300 allows a user (e.g., such as user 102 in FIGS. 1A and 1B) to select a type of narrative 310. This selection may be provided as input to a narrative creation system (e.g., such as narrative creation system 130 of FIG. 1A) to trigger the narrative creation system generate a narrative of the selected type of narrative 310. Example narratives that may be created by the narrative creation system may include a pitch, a value proposition, a problem statement, an impact statement, a solution statement, a business case statement, a pitch deck, a summary, a simplified version, BLUF, an article, a one-pager, a case study (e.g., standalone), a white paper, a press release of the future (e.g., an innovation story), a thought leadership article: problem-solution, a patient story article, a thought leadership article: technology insights article, a challenge story, a testimonial, a social media post, an elevator pitch, a research (e.g., detailed technical) report, a thought leadership Article: how to article, a thought leadership article: an opposite-the editorial (op-ed) article, a thought Leadership article: paradigm shift, a thought leadership article: perspectives/commentary article, a video script, an executive summary transformation, a presentation (e.g., a general-purpose presentation), a slide deck, a research and development presentation, a product demos, a product overviews presentation, a sustainability presentation, a CSR initiatives presentation, a regulatory and compliance training presentation, a strategy and key objectives presentation, a meeting with the board presentation, a corporate deck, a business strategy presentation, a technical demonstrations presentation, investor and/or stakeholder update(s), training and educational Material, a sales and marketing pitch, a project status report, pitch transformations (e.g., timing, length, etc.), a project status report (e.g., during a project), a project report (e.g., close out), a project plan, a PRD, user stories, a project update generator (e.g., transform of report, less formal), an innovation story based on a Breaking Through at Last pattern, an innovation story based on a Discovering Happy Accidents pattern, an innovation story such as an origin story, an innovation story based on a Solving the Problem pattern, an innovation story such as a failure story, an invention disclosure (e.g., internal to a company, which may be confidential), an innovation story such as a project pre-mortem story, an after action review (e.g., project post-mortem), epics (e.g. product use cases), acceptance criteria (e.g., product use cases), an explainer video script, product technical specifications (e.g., a mini-PRD), among others.

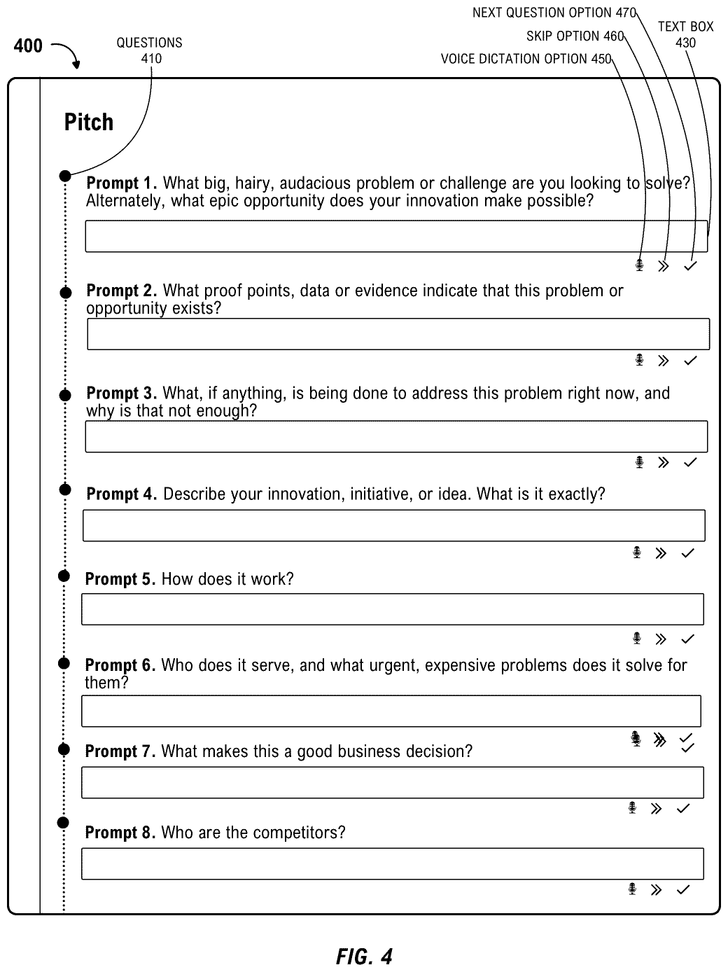

FIG. 4 illustrates an example pitch user interface 400, after a user has selected the pitch option (e.g., an example type of narrative) from a starting UI, such as starting user interface 300 in FIG. 3. Pitch user interface 400 may include a series of example prompts 410 triggering a response by the user. In certain embodiments, the prompts 410 may include one or more statements and/or one or more questions. As shown, example prompts 410 may include:
Prompt 1. What big, hairy, audacious problem or challenge are you looking to solve? Alternately, what epic opportunity does your innovation make possible?
Prompt 2. What proof points, data or evidence indicate that this problem or opportunity exists?
Prompt 3. What, if anything, is being done to address this problem right now, and why is that not enough?
Prompt 4. Describe your innovation, initiative, or idea. What is it exactly?
Prompt 5. How does it work?
Prompt 6. Who does it serve, and what urgent, expensive problems does it solve for them?
Prompt 7. What makes this a good business decision?
Prompt 8. Who are the competitors?

It should be noted that the list of prompts 410 are only example prompts that may be presented to a user. In other words, the example prompts listed are not an exhaustive list, and one or more other example prompts not listed herein may be considered and used in other examples . . . .

Each prompt 410 may allow a user to input, in natural language, a response. For example, a prompt including a question may prompt a user to provide an answer to the question. The text box 430 corresponding to each prompt 410 allows the user to enter their response to the respective prompt 410. In certain embodiments, voice dictation option 450 allows for a user to say their response. This speech may be picked up by the system and translated into text. In certain embodiments, a skip option 460 may be available. The skip option 460 may enable a user to skip one or more of the prompts (i.e., not provide a response to the prompt(s)). In certain embodiments, next question option 470 may enable a user to input their text or voice answers and move to the next question. In certain embodiments, previous question option 480 may enable a user to return to a previous question to edit their previously-provided response. The responses to prompts 410 may be stored in a user database, such as stored as user input 136 in user database 124 shown in FIG. 1B. In certain embodiments, the user database may retrieve the responses to prompts 410, such as from a browser's cache used by the user.

In certain embodiments, the prompts provided to a user (e.g., such as prompts 410 shown in FIG. 4) may change dynamically, based on responses to previous prompts. For example, an AI/ML engine may determine, with iterations that certain prompts work better for the telecommunication industry than the bottling industry. This is in contrast to prior art that utilized a rote series of dozens of questions that could not change dynamically based on ML-improved algorithms, and required certain formatting in specific answers, such as numbers and other data. The present disclosure can ingest natural language answers in a variety of formats and writing styles, with fewer questions. Total question needed are often approximately 10 or fewer.

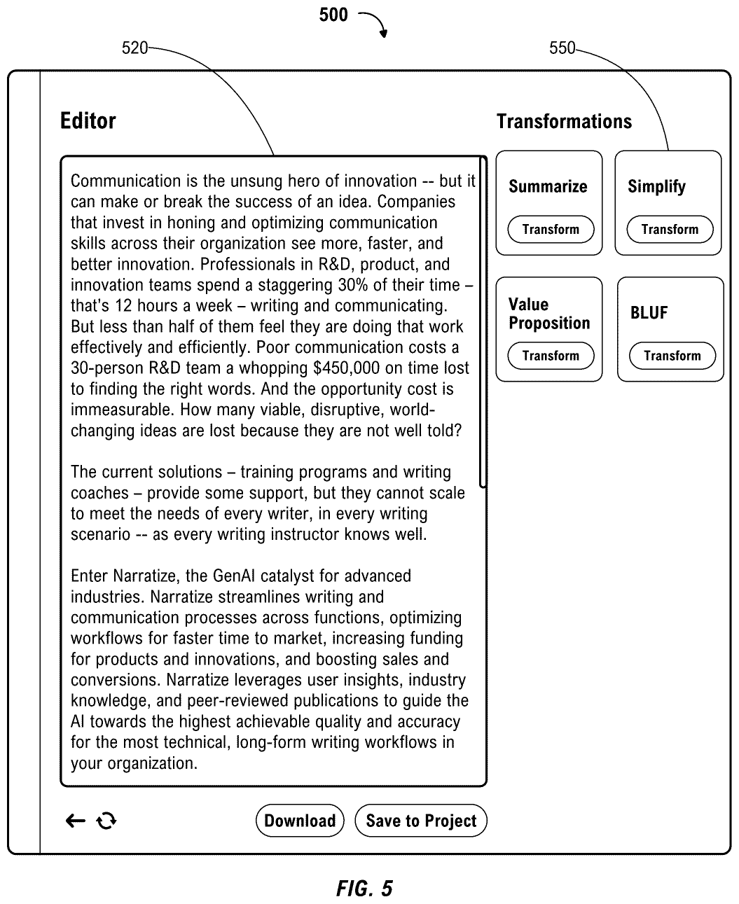

FIG. 5 illustrates a final pitch user interface 500 displaying a pitch 520 (e.g., an example narrative) created by a narrative creation system (e.g., such as narrative creation system 130 of FIG. 1A). In certain embodiments, the narrative creation system may (1) use one or more LMs (e.g., such as LM 118 and/or LM 120) to analyze the user input stored in the user database (along with one or more stories and/or one or more data insights) and (2) use a narrative generator, such as implementing an AI/ML engine, to develop the pitch 520.

In certain embodiments, after generating pitch 520, final pitch user interface may provide the user with one or more conversion options 550. Conversion options 550 enable the user to convert the generated pitch 520 into one or more other types of narratives (e.g., other format(s)). For example, the user may also desire to create a social media post about a topic discussed in pitch 520 and/or a summary for the topic discussed in pitch 520. The user may select one or more of the conversion options 550 to trigger the narrative creation system to generate the other selected narrative type(s).

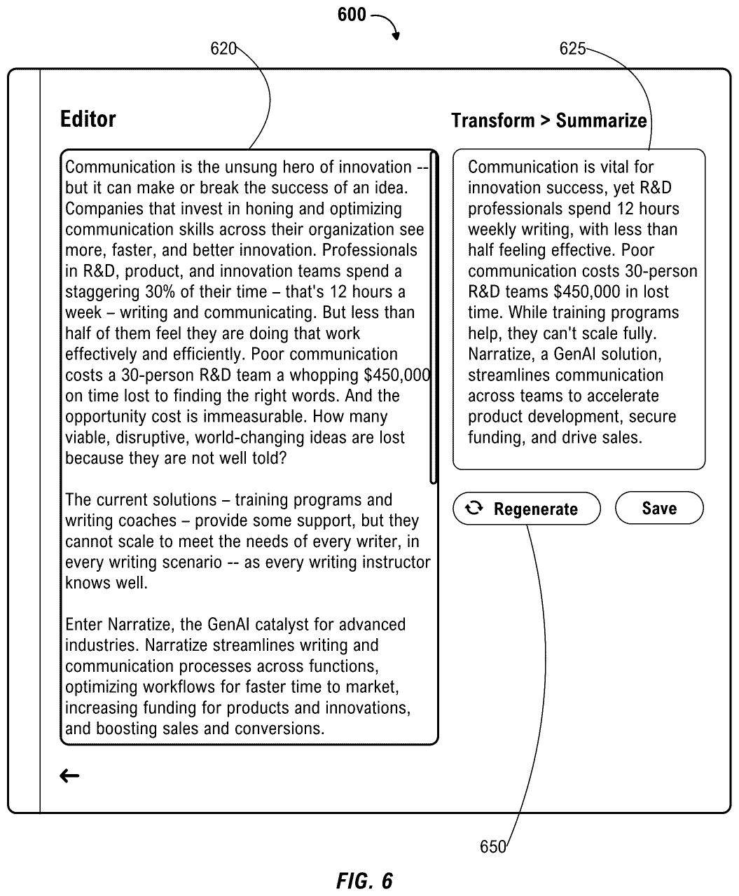

FIG. 6 illustrates an example conversion user interface 600 including a generated narrative of a first narrative type, e.g., a pitch 620, and a generated narrative of a second narrative type, e.g., a summary 625. In FIG. 6, summary 625 may be generated from the pitch 620, user input stored in the user database, one or more stories stored in an information repository, and/or one or more data insights stored in an information repository. In certain embodiments, summary 625 may be regenerated into another narrative type based on the user pressing the “regenerate” button 650. One or more LMs and the narrative generator may be used to convert pitch 620 to summary 625, and/or to one or more other narrative types.

### Example Narrative Structures

In certain embodiments, creating a narrative using the narrative creation system described herein (e.g., narrative creation system 130 in FIG. 1A) may involve applying an appropriate narrative structure. Certain structures may be more conducive to one pagers, or pitches, etc. An ML/AI engine may be trained to determine the best structures for various narrative types. FIG. 7 illustrates an example narrative structure: set the stage→rising action→climax→falling action→tie it together. This could also be called: characters and setting→problem or challenge→resolution. Other structures may include: hero's journey, Pixar® structure, discovering happy accidents, and others.

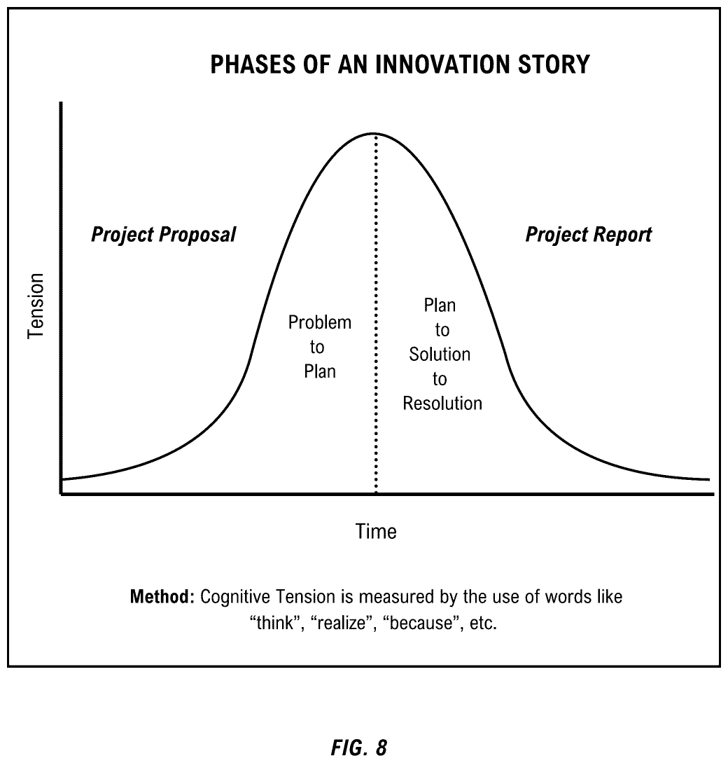

In certain embodiments, portions of a narrative structure may be mapped to cognitive tension. For example, FIG. 8 illustrates cognitive tension associated with phases of an innovation story (project proposal (problem to plan)→project report (plan to solution or resolution)). If someone wants an innovation story (or an AI/ML engine determines that this structure is best), then cognitive tension may follow the tension shown in the graph in FIG. 8. Alternatively, if a desired narrative were a project proposal, then the final narrative may follow the tension shown in the first half of the graph. Similarly, if the desired narrative is a project report, then the final narrative may follow the tension shown in the second half of the graph. One method of manipulating cognitive tension is through the use of certain words, such as using “like,” “think,” “realize,” and/or “because” to indicate tension. Periods of increasing tension may include more of these example types of words, while periods of declining tension may use fewer of these example types of words.

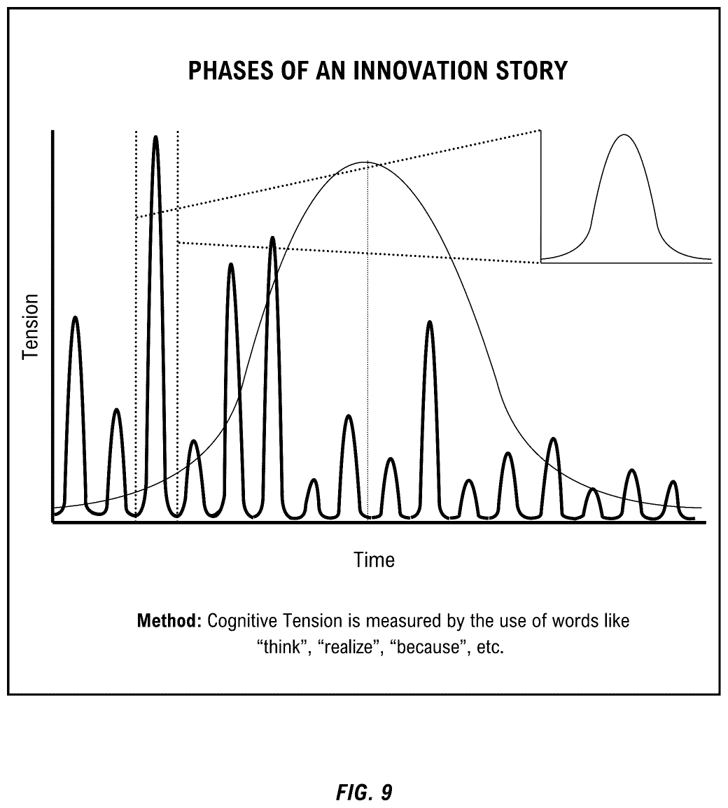

In certain embodiments, narrative structures may include a plurality of micro stories, not a perfect increase and decrease of tension as shown in FIG. 8. For example, a narrative that is intended to follow the tension in the graph shown in FIG. 8 may include a variety of micro stories, that when analyzed by a narrative creation system (e.g., narrative creation system 130 shown in FIG. 1A), may exhibit the behavior shown in FIG. 9.

FIG. 9 illustrates a series of increases and decreases in tension. The narrative creation system may rearrange the order of micro stories, or rearrange the verbal description of each micro story, such as to more closely resemble the tension shown in the graph of FIG. 8. Alternatively, the micro story that best matches the tension in the graph of FIG. 8 may be kept and other material edited out, such as to cause tension that best matches the tension shown in FIG. 8.

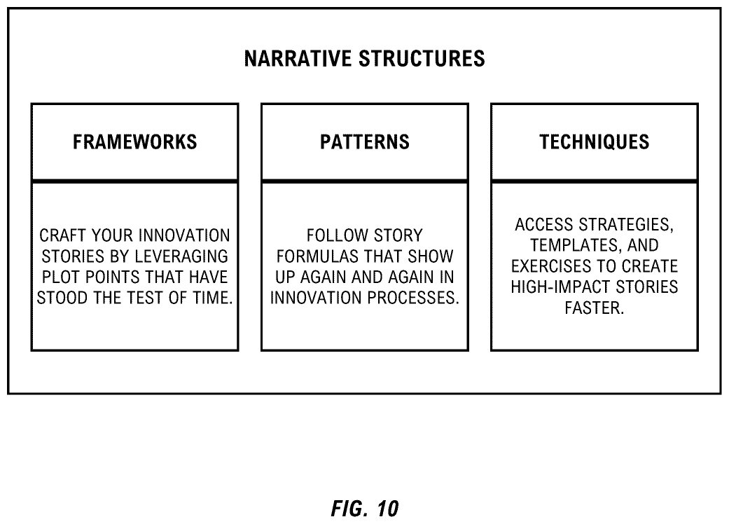

In certain embodiments, narrative structures may include frameworks, patterns, and/or techniques, as shown in FIG. 10. Frameworks may rely on plot points that can be repeated across a variety of narratives. Patterns may be more focused on story formulas that tend to be repeated. Techniques may include different strategies and/or templates for applying the frameworks and/or patterns to specific scenarios.

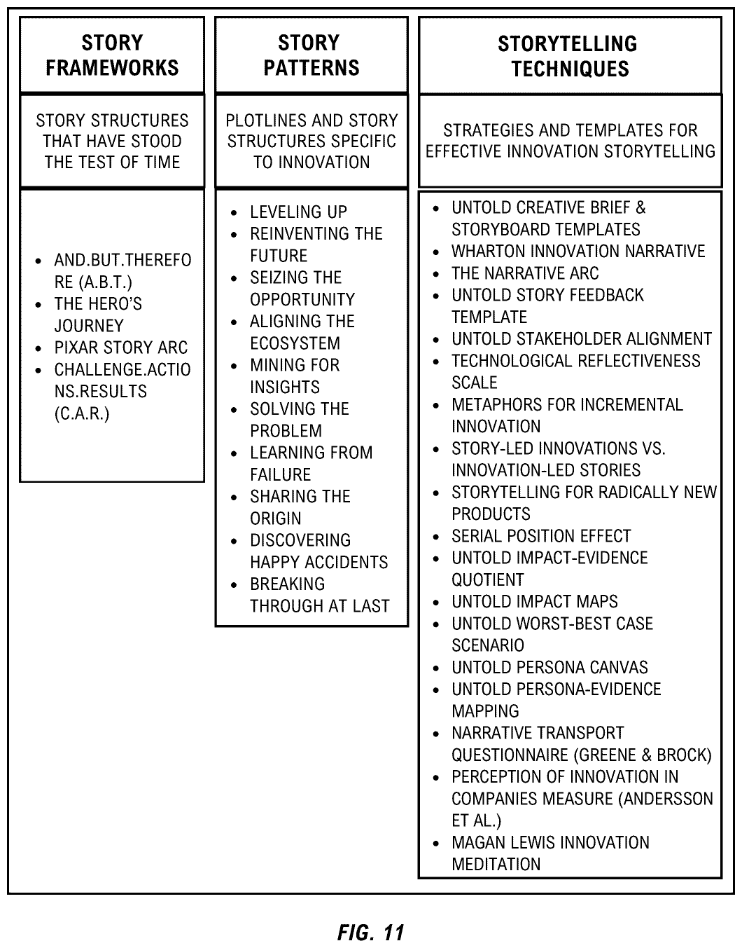

Examples of frameworks, patterns, and techniques are shown in FIG. 11. Example frameworks may include And, But, Therefore (ABT), the Hero's Journey, Pixar® structure, and/or Challenge, Action, Results (CAR), to name a few.

The ABT (or And/But/Therefore) framework is a simple yet powerful framework that has inspired high-impact stories from healthcare to aerospace. Adapted from the narrative framework of South Park by marine biologist Randy Olson, the ABT framework allows for a story to be condensed down to its core elements of goals, tensions, and/or calls to action. The ABT framework may provide a way to set up a problem, with tension, such that that an innovation helps to resolve. The ABT framework follows: There is an ordinary world AND something at stake, BUT there's a key tension or problem with that current state, THEREFORE a solution or answer is needed. This framework may be useful for communicating opportunities arising from challenges. The framework may be beneficial for presenting to industry audiences, pitching investors, or getting internal leadership buy-in for new innovation pathways that could solve a big industry or market challenges.

The Hero's Journey framework is an archetypal story framework detailing a journey that transforms a main character and the world they impact. The Hero's Journey framework may be utilized when marketing a product or service (i.e. the customer is typically the hero), for example. Further, when the framework is applied to innovation contexts, the hero may have many other “faces.” For example, the hero may be the solopreneur working out of their garage (e.g., think Bill Gates) or the brilliant innovation team creating tomorrow's next consumer adaptive technology (e.g., think social Labs) or even a desirable future state (e.g., like a world where human mobility sees near-perfect safety). Each hero's journey tries to inspire individuals to be more innovative.

The Pixar story arc of routine, disruption, change, and growth beneficially helps to immerse audiences in a story. This framework may help to convey an important “life lesson” while telling an empathetic story of innovation. The arc may begin in the ordinary, everyday world, highlight a tension, and then reveal how an organization has intervened. This arc may reveal how organizational ingenuity leads to better solutions. In some cases, the Pixar story arc provides a powerful way to demonstrate commitment to change and to demonstrate how an organization has responded to a challenge. In a 5-step process, this template offers, in certain embodiments, a framework for discussing internal growth within an organization. In certain embodiments, this template may be applied to an external challenge that prompts an organization to respond.

In innovation, there are challenges and obstacles that may need to be overcome in order to achieve one or more goals. Often used in personal branding or interviewing to share professional capabilities, the CAR framework may provide a useful way to explain decisions, pivots, detours, and/or plans to stakeholders. When communicating with these parties, structuring a story to contextualize the challenges faced, share the actions taken in response to those challenges, and the results may provide an effective way to obtain organizational buy-in for innovation decisions. While the CAR framework may be used to illustrate successes and/or highlight unique value proposition, the framework may be particularly useful to explicate missteps in innovation processes. When things don't go as planned, aligning with stakeholders and maintaining credibility and trust is important. The CAR framework may help with explicating how individuals have responded to those challenges and/or failures when the “results” aren't ideal. In these cases, the story becomes cyclical and loops back from challenge>action>results to challenges>action, and so on, to explain the pivots and/or detours. Ultimately, the plot may not end with the “results” at all but rather end with the actions that are expected to be taken and may serve as a way of instilling cultural and behavioral value.

Example patterns may include Leveling Up, Reinventing the Future, Seizing the Opportunity, Aligning the Ecosystem, Mining for Insights, Solving the Problem, Learning from Failure, Sharing the Origin, Discovering Happy Accidents, and/or Breaking Through At Last, to name a few.

The Leveling Up story pattern may be useful for communicating incremental innovations. Internally, this pattern may be used to help stakeholders recognize gaps in current models and/or green-light opportunities for addressing them. For consumers, this pattern may help to focus on highlighting significant improvements, inspiring those who bought earlier iterations of a product to upgrade. By developing a link between past positive experiences with a company and the promise of future positive experiences, this story pattern may help to build on customer loyalty, in certain embodiments. In certain embodiments, the story pattern may center less on the journey or process of how a new innovation was created and more on the actual product, what makes it better, and why it is worth leveling up from an old product or a competitor's product. For internal stakeholders, the pattern may be similar, but emphasizing why it's worthwhile for a company to invest the effort may be beneficial.

The Reinventing the Future pattern allows a storyteller to detach its audience from their current reality and visualize a future state where they (e.g., the audience) can see the full impact of a new innovation and/or also foresee what may be true for the innovation to reach its full potential (i.e., inspire narrative transport). The Reinventing the Future pattern may also allow a storyteller to provide sufficient evidence such as to demonstrate the feasibility of the future a gain buy-in (i.e. achieve narrative persuasion).

Seizing the Opportunity is a story pattern that may help to communicate emerging trends and/or ideas for products and/or services that align with that trend, such as to garner buy-in for new opportunity spaces.

Aligning the Ecosystem story pattern not only allows for the alignment of organization, but may help to rally together entire ecosystems and regions around a shared vision of innovation. Aligning stories within a regional ecosystem is critical for creating regional innovation narratives that attract new talent, organizations, institutions and investors.

The Mining for Insights story pattern is commonly used in design sprints and ideation sessions. The Mining for Insights story pattern is a pattern used to collect and share deep insights that get at the heart of consumer and stakeholder values, needs, and/or preferences. This pattern may be useful when wanting to represent the voices and insights of others in innovation stories. This pattern may help to direct empathy towards those who are not in the conversation. Thus, this story may help to represent people with nuance-fighting assumptions and stereotypes.

The Solving the Problem story pattern may enable a storyteller to convey cultural values around risk-taking, rapid learning, and/or pivoting to achieve success. “Redemption” is often a key element of the Solving the Problem story pattern because this pattern moves from a major challenge or hurdle to key actions that may course-correct and/or solve the problem and, in some cases, result in success.

The Learning from Failure story pattern may enable a storyteller to position their next failure as an experience that is aligned with the organization's innovation strategy. Further, the Learning from Failure story pattern may help to position the storyteller for a next project.

The Sharing the Origin story pattern may focus on the inceptions of an innovation and/or company. The Sharing the Origin story pattern may be used across diverse innovation contexts, such as when communicating a readiness to scale up or launch, when first meeting an investor, when onboarding new employees or team members, and/or when sharing a company's story with a broader public audience.

The Discovering Happy Accidents story pattern may be useful for sharing unintended, happenstance discoveries. For example, the Discovering Happy Accidents story pattern may be used when communicating with stakeholders about innovations that don't fit perfectly within their vision and/or annual roadmaps. When discovering a happy accident, the initial excitement is often tempered by the fact that an internal buy-in is needed for an innovation that no one planned on.

The Breaking Through at Last story pattern may be helpful when needing to communicate a breakthrough after a long, circuitous innovation journey. When failures and/or roadblocks slow down or change anticipated plans, communicating that journey to other others, such as stakeholders, may be necessary (e.g., such that those individuals hopefully share a breakthrough). Similar to the Solving the Problem story pattern, the Breaking Through at Last story pattern may follow a traditional story arc including a beginning, middle, and end, and the cognitive tension may be resolved by the end of the story (e.g., such as through a successful innovation).

Examples techniques may include proprietary templates, Wharton Innovation Narrative, The Narrative Arc, proprietary feedback templates, proprietary stakeholder alignment, Technological Reflectiveness Scale, Metaphors for Incremental Innovation, Story-led Innovation vs. Innovation-led Stories, Storytelling for Radically New Products, and/or a Serial Position Effect, to name a few.

The Wharton Innovation Narrative, associated with the Wharton Business School at the University of Pennsylvania, may serve as a rallying cry throughout an organization. The Wharton Innovation Narrative may help to inspire employees, collaborators, and/or customers with clear, aspirational messaging about a mission, vision, and/or values, such as with respect to innovation and growth.

The Narrative Arc may allow a user to evaluate how a story is structured. It has identified three primary processes that emerge across stories and narratives-staging, plot progression, and/or cognitive tension. In certain embodiments, this technique may be used to create a line chart mapping of a story's processes based on the story's text.

The Technological Reflectiveness Scale may be an “easy-to-administer” instrument used to identify an individual's level of technological reflectiveness. This validated measure may provide a helpful way to determine how technologically reflective the audience is (e.g., put differently, how much capacity the audience has to think about the societal impacts of an innovation). Technological reflectiveness (TR) refers to the tendency to think about the societal impact of an innovation. TR may also capture a person's ability to open their mind to different and/or more elaborate features and/or use-cases for an existing innovation. Individuals with high TR may have the capacity to generate ideas that enhance a technical product's impact on end-users and/or society more broadly. When invited to respond to innovation stories, individuals with higher TR may tend to give more meaningful feedback.

Metaphors for Incremental Innovation is a technique that promotes the use of metaphors when storytelling about incremental innovations, but cautions to avoid metaphors for radically new innovations. In certain embodiments, this technique may help to identify the types of metaphors that work best for storytelling about incremental innovations and/or systems improvements. Because a good metaphor can help consumers visualize and give more meaningful feedback on incremental innovations, this technique may be beneficial for harnessing empathy and/or using storytelling to create a two-way conversation with consumers.

For many innovation story patterns, drivers, and/or epic examples, it may be helpful to understand one major distinction, e.g., whether an invocation story is categorized as a story-led innovation or an innovation-led story. Story-led Innovations may include efforts that start with a clear problem statement driving the need for innovation. Story-led innovation efforts may have approved technical briefs that articulate a problem that is already aligned with organizational goals, visions, and/or understanding of the marketplace. Stories categorized within this type of innovation may align with that original problem statement and/or share a solution against it. On the other hand, innovation-led stories include those efforts that fall outside of organizational problem statements, visions, and/or strategic plans. From accidental discoveries to white space opportunities, innovation-led stories may begin with a finding, an insight, or an opportunity rather than with a problem statement. Some innovators may refer to these stories as “solutions in need of a problem.” Innovation-led stories may lack a clear narrative and/or may struggle to achieve organizational alignment, making it difficult for innovators to communicate the potential value and impact.

Storytelling for Radically New Products refers to a narrative structure that may be used to increase consumer adoption intent for radically new products. Its premise is that radically new product concepts are best communicated to potential consumers through stories that feature a main character, using the product, in the realistic location of use, and experiencing its outcomes (i.e., product benefits). In certain embodiments, when used in concept tests, this storytelling technique may help to increase consumer understanding and adoption intent. In certain embodiments, this storytelling technique may position consumers to give more meaningful feedback on radically new product and/or service concepts.

Neuroscience research suggests that humans may more easily forget the middle of a story, speech, or any other piece of content. Thus, the Serial Position Effect reminds a storyteller to put the most important information at the beginning and at the end of a story such that the audience will remember the more important content. This technique may be particularly useful for ensuring that evidence and content align with audience needs. For example, this technique may start with high-impact, highly engaging content and end with a clear call to action that motivates audiences toward a desired goal.

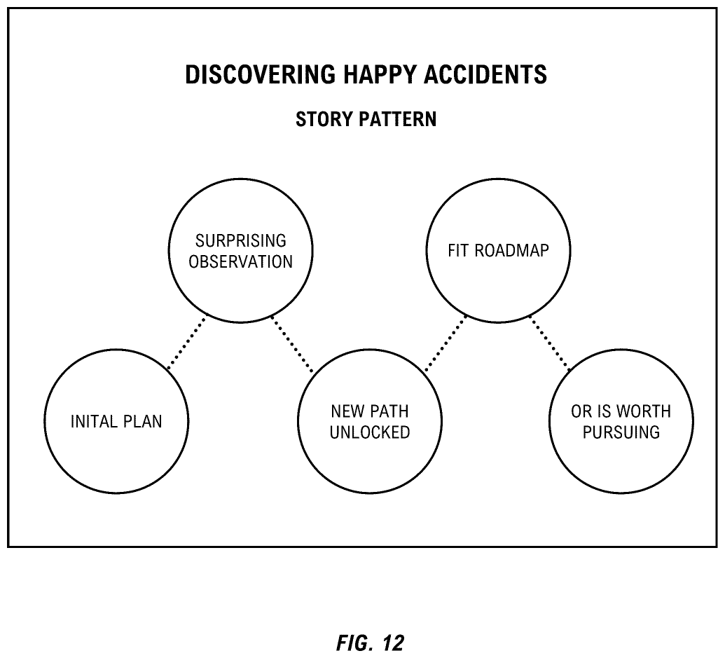

FIG. 12 illustrates an example Discovering Happy Accidents pattern. This pattern comprises multiple parts including: initial plan→surprising observation→new path unlocked→fit roadmap→ or with worth pursuing.

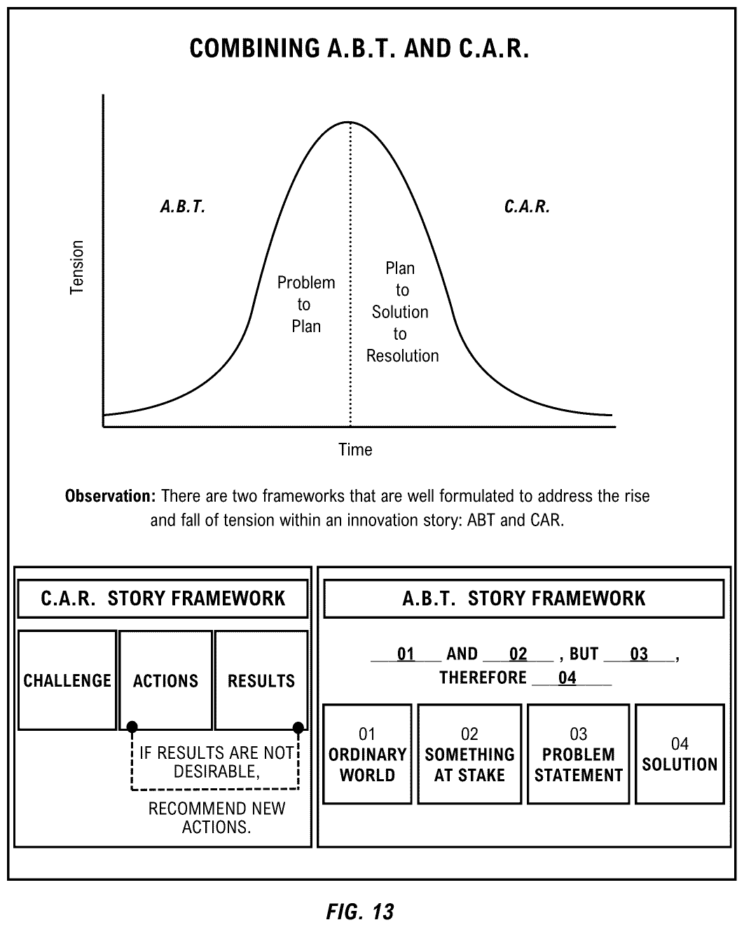

The frameworks, patterns, and techniques described herein are not exhaustive, and each given example may have various sub-variations. Various examples may also be combined with other examples. For example, FIG. 13 illustrates example combining of two frameworks: ABT and CAR. ABT may be used in the first half of an innovation story (e.g., an example narrative type), such as with increasing tension, while CAR may be used in the second half the innovation story, such as with decreasing tension.

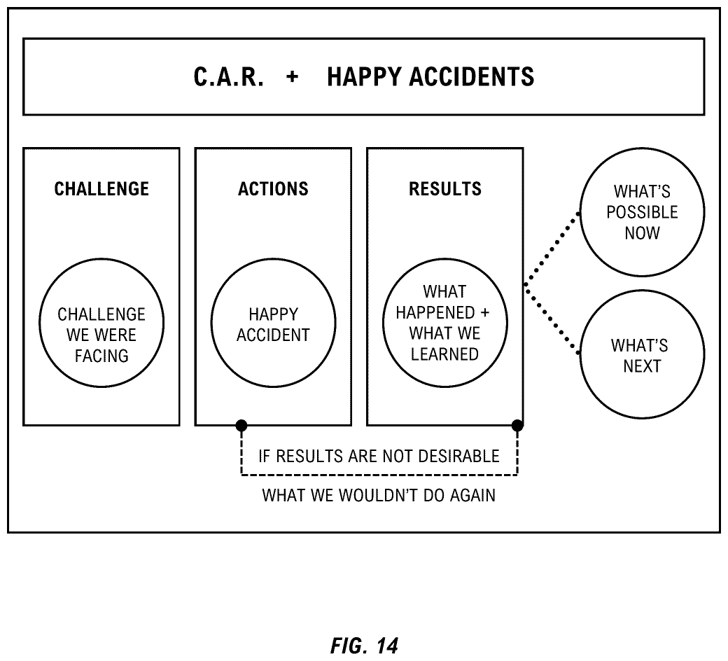

In certain embodiments, CAR may also be combined with Happy Accidents, as shown in FIG. 14.

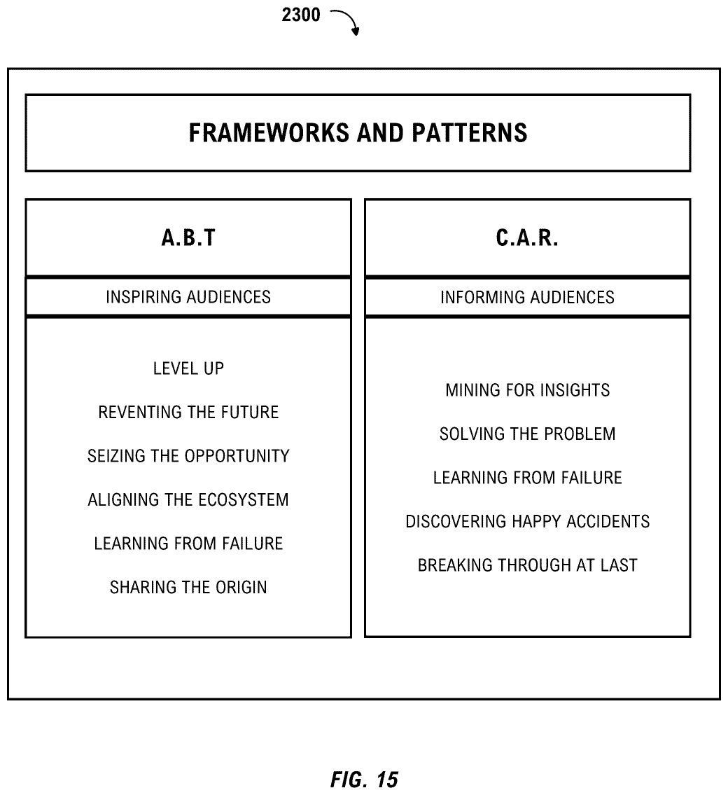

Other examples of combining frameworks and patterns are shown in FIG. 15. ABT may be considered as a framework for inspiring audiences, generally with increasing tension. Typical patterns for this type of framework may include Leveling Up, Reinventing the Future, Seizing the Opportunity, Aligning the Ecosystem, Learning from Failure, and/or Sharing the Origin. On the other hand, CAR may be considered as a framework for informing audiences, generally with decreasing tension. Typical patterns for this type of framework may include Mining for Insights, Solving the Problem, Learning from Failure, Discovering Happy Audiences, and/or Breaking through at Last.

When a user uses the narrative creation system described herein to create a narrative, the narrative creation system may provide the user with options to see the desired work product when applying different frameworks, patterns, and techniques. For example, a user may select a regenerate button (e.g., such as regenerate button 650 of FIG. 6) and the user may then be presented with a user interface, the user interface shown in FIG. 15, or another list of available frameworks, patterns, and/or techniques from which to select. After making a selection, the narrative creation system may regenerate the narrative (e.g., a white paper, or one pager) but with the application of a different framework, pattern, and/or technique.

### Example Computing Device

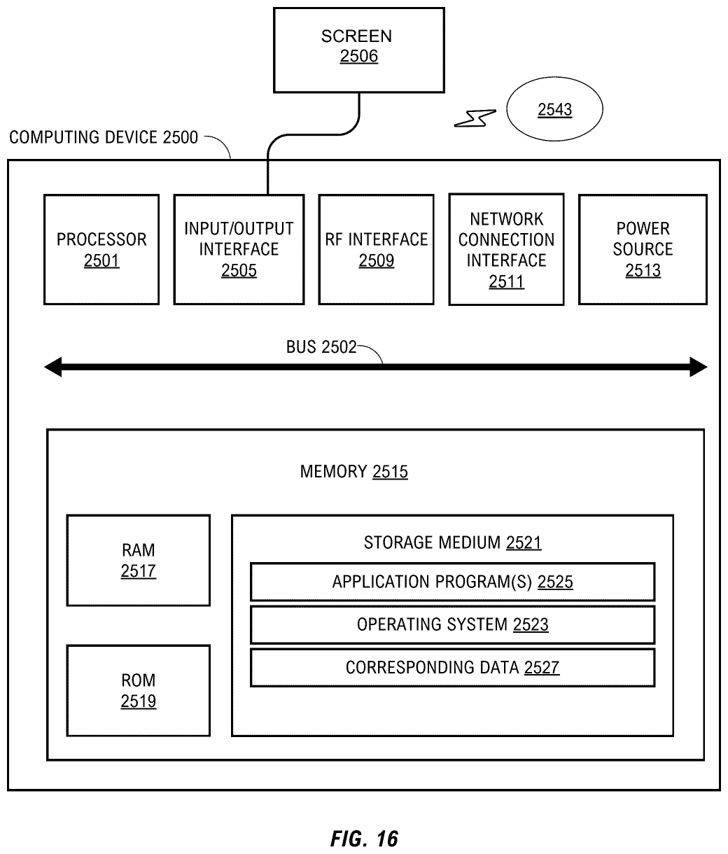

FIG. 16 illustrates an example computing device 2500 that may include a narrative creation system, such as narrative creation system 130 of FIG. 1A, or components thereof, such as a story infuser, a document analyzer, a narrative generator, a retrieval engine, one or more LMs, an information repository, and a user database, configured to implement or perform aspects of the present disclosure. Computing device 2500 may be used to: perform narrative generation tasks; provide intercommunication between a story infuser, a document analyzer, a narrative generator, a retrieval engine, one or more LMs, an information repository, and a user database; receive and store user information; perform AI and/or ML tasks and analyses of data; analyze and/or optimize; and/or perform other related tasks and data analytics.

Computing device 2500 includes a processor 2501 that is operatively coupled via a bus 2502 to an input/output (I/O) interface 2505, a power source 2513, a memory 2515, a radio frequency (RF) interface 2509, a network communication interface 2511, and/or any other component not shown. In certain embodiments, computing device 2500 may utilize all or a subset of the components shown in FIG. 16. The level of integration between the components may vary from one embodiment to another. Further, in certain embodiments, computing device 2500 (or components thereof) may include multiple instances of a component, such as multiple processors, memories, transceivers, transmitters, receivers, etc.

The processor 2501 is configured to process instructions and data and may be configured to implement any sequential state machine operative to execute instructions stored as machine-readable computer programs in memory 2515. Processor 2501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 2501 may include multiple central processing units (CPUs).

In the example, input/output interface 2505 may be configured to provide one or more interfaces to one or more input devices and/or one or more output devices, such as screen 2506. Examples of an output device may include a speaker, a sound card, a video card, a display, a monitor, a printer, an actuator, an emitter, a smartcard, another output device, or any combination thereof. An input device may allow a user to capture information in computing device 2500. Examples of an input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, or any combination thereof. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In certain embodiments, the power source 2513 is structured as a battery or battery pack. Other types of power sources, such as an external power source (e.g., an electricity outlet), photovoltaic device, or power cell, may be used. The power source 2513 may further include power circuitry for delivering power from the power source 2513 itself, and/or an external power source, to the various parts of computing device 2500 via input circuitry or an interface such as an electrical power cable.

Memory 2515 may be configured to include memory such as random access memory (RAM) 2517, read-only memory (ROM) 2519, programmable read-only memory (PROM), erasable programmable read-only memory (EPROM), electrically erasable programmable read-only memory (EEPROM), magnetic disks, optical disks, hard disks, removable cartridges, flash drives, other storage medium 2521, and so forth. In one example, the memory 2515 includes one or more application programs 2525, an operating system 2523, web browser application, a widget, gadget engine, or other application, and corresponding data 2527. Memory 2515 may store, for use by the computing device 2500, any of a variety of various operating systems or combinations of operating systems. An article of manufacture, such as one including a simulation system or communication system may be tangibly embodied as or in memory 2515, which may be or comprise a device-readable storage medium.

Processor 2501 may be configured to communicate with a network 2543, such as an access network or other network, using the RF interface 2509 or network connection interface 2511. The RF interface 2509 or network connection interface 2511 may comprise one or more communication subsystems and may include or be communicatively coupled to an antenna. In the illustrated embodiment, communication functions of the RF interface 2509 or network connection interface 2511 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

In certain embodiments, computing device 2500 may perform methods such as AI/ML-based methods described herein, and other method embodiments under the present disclosure. It may perform other AI/ML-based methods as described further below, for e.g., what framework, pattern or technique to use for certain desired document types based on e.g., what industry is at issue. For example, for a given industry, it may be determined through iteration, that certain frameworks are more effective at communicating innovation than other frameworks. Benefits or disadvantages, such as user response, or marketing successes, may be recorded and incorporated into training by AI/ML analyses. In certain embodiments, the computing device 2500 can include an AI/ML engine for training or implementing an AI/ML model. The architecture of an ML model (e.g., structure, number of layers, nodes per layer, activation function etc.) may need to be tailored for each particular use case. For example, properties to vary may include framework/pattern/technique type, industry, and/or other data which can impact optimization of narrative generation. One or more of these properties may need to be considered when designing the ML model's architecture.

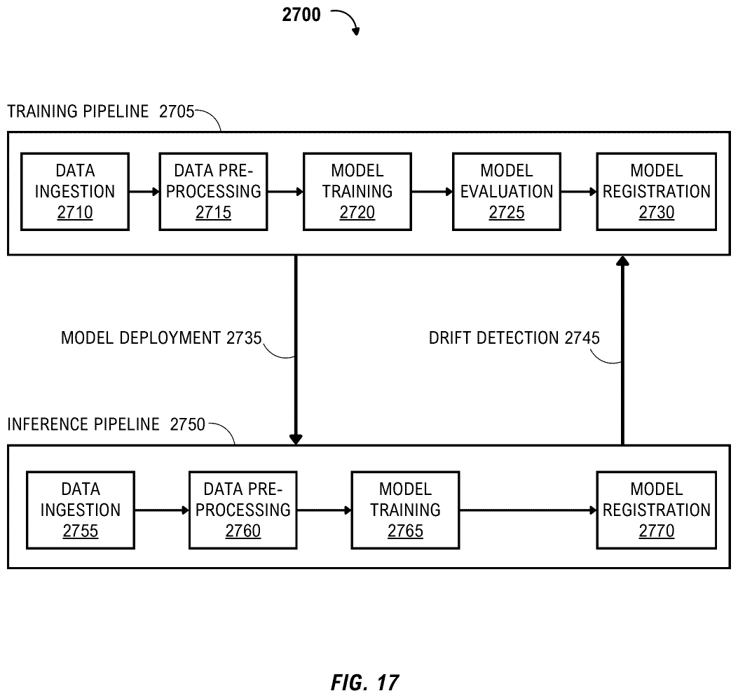

Building an AI/ML model may include several development steps where the actual training of the ML model is just one step in a training pipeline. An important part in AI/ML development is the AI/ML model lifecycle management. One embodiment of a model lifecycle management procedure 2700 is illustrated in FIG. 17. The model lifecycle management comprises two pipelines: a training pipeline 2705 and an inference pipeline 2750.

At 2710 in the training pipeline 2705, data ingestion 2710 occurs, which includes gathering raw (training) data from a data storage. After data ingestion 2710, there may also be a step that controls the validity of the gathered data. At 2715 data pre-processing occurs, which can include feature engineering applied to the gathered data. This may involve, e.g., data normalization or data formatting or transformation required for the input data to the AI/ML model. After the ML model's architecture is fixed, it should be trained on one or more datasets. At 2720 model training is performed in which the AI/ML model is trained with the raw training data. To achieve good performance during live operation in a system (the so-called inference phase), the training datasets should be representative of actual data the ML model will encounter during live operation. The training process often involves numerically tuning the ML model's trainable parameters (e.g., the weights and biases of the underlying neural network (NN)) to minimize a loss function on the training datasets. The loss function may be, for example, based on a measure of cognitive tension, adherence to a framework/pattern/technique (e.g., paragraph, length, tone, headings, pages), consumer response to a document or marketing effort, or other output. The purpose of the loss function is to meaningfully quantify the reconstruction error for the particular use case at hand. At 2725 model evaluation can be performed where the performance is benchmarked to some baseline. Model training 2720 and evaluation 2725 can be iterated until an acceptable level of performance is achieved. At 2730 model registration occurs, in which the AI/ML model is registered with any corresponding data on how the AI/ML model was developed, and e.g., AI/ML model evaluation data. At 2735 model deployment occurs, wherein the trained/re-trained AI/ML model is implemented in the inference pipeline 2750.

Data ingestion 2755 in the inference pipeline 2750 refers to gathering raw (inference) data from a data source. Data pre-processing 2760 can be essentially identical/similar to the data pre-processing 2715 of the training pipeline 2705. At 2765, the operational model received from the training pipeline 2705 is used to process new data received during operation of e.g., computing device 2500 of FIG. 16 or narrative creation system 130 of FIG. 1A. At 2770 data and model monitoring is performed. Here the inference data is analyzed to determine whether the inference data are from a distribution that aligns with the training data, as well as monitoring model outputs for detecting any performance, or operational, variance or drifts. The variance or drift is used at 2745 (drift detection) to update the AI/ML model registration.

The training process is typically based on some variant of a gradient descent algorithm, which, at its core, can comprise three components: a feedforward step, a back propagation step, and a parameter optimization step. These steps can be described using a dense ML model (i.e., a dense NN with a bottleneck layer) as an example.

Feedforward: A batch of training data, such as a mini-batch, (e.g., several downlink-channel estimates) is pushed through the ML model, from the input to the output. The loss function is used to compute the reconstruction loss for all training samples in the batch. The reconstruction loss may be an average reconstruction loss for all training samples in the batch.

The feedforward calculations of a dense ML model with N layers (n=1, 2, . . . , N) may be written as follows: The output vector a^{[n]} of layer n is computed from the output of the previous layer a^{[n-1]} using the equations:

$${z}^{[ n ]} = {W}^{[ n ]} \cdot {a}^{[ n - 1 ]} + {b}^{[ n ]} , {a}^{[ n ]} = g ( {z}^{[ n ]} ) \qquad ( 1 )$$

In the above equation, W^{[n]} and b^{[n]} are the trainable weights and biases of layer n, respectively, and g is an activation function applied elementwise (for example, a rectified linear unit).

Back propagation (BP): The gradients (partial derivatives of the loss function, L, with respect to each trainable parameter in the ML model) are computed. The back propagation algorithm sequentially works backwards from the ML model output, layer-by-layer, back through the ML model to the input. The back propagation algorithm is built around the chain rule for differentiation: When computing the gradients for layer n in the ML model, it uses the gradients for layer n+1.

For a dense ML model with N layers the back propagation calculations for layer n may be expressed with the following well-known equations:

$$\frac{\partial L}{\partial {a}^{[ n ]}} = {[ {W}^{[ n + 1 ]} ]}^{T} \cdot \frac{\partial L}{\partial {z}^{[ n + 1 ]}} \qquad ( 2 )$$

$$\frac{\partial L}{\partial {z}^{[ n ]}} = \frac{\partial L}{\partial {a}^{[ n ]}} * {g}^{{[ n ]}^{′}} ( {z}^{[ n ]} ) \qquad ( 3 )$$

$$\frac{\partial L}{\partial {W}^{[ n ]}} = \frac{\partial L}{\partial {z}^{[ n ]}} \cdot {[ {a}^{[ n - 1 ]} ]}^{T} \qquad ( 4 )$$

$$\frac{\partial L}{\partial {b}^{[ n ]}} = \frac{\partial L}{\partial {z}^{[ n ]}} \qquad ( 5 )$$

where * here denotes the Hadamard multiplication of two vectors.

Parameter optimization: The gradients computed in the back propagation step are used to update the ML model's trainable parameters. An approach is to use the gradient descent method with a learning rate hyperparameter (α) that scales the gradients of the weights and biases, as illustrated by the following update equations:

$${W}^{[ n ]} = {W}^{[ n ]} - α \cdot \frac{\partial L}{\partial {W}^{[ n ]}} \qquad ( 6 )$$

$${b}^{[ n ]} = {b}^{[ n ]} - α \cdot \frac{\partial L}{\partial {b}^{[ n ]}} \qquad ( 7 )$$

It is preferred to make small adjustments to each parameter with the aim of reducing the average loss over the (mini) batch. It is common to use special optimizers to update the ML model's trainable parameters using gradient information. The following optimizers are widely used to reduce training time and improve overall performance: adaptive sub-gradient methods (AdaGrad), RMSProp, and adaptive moment estimation (ADAM).

The above process (feedforward, back propagation, parameter optimization) is repeated many times until an acceptable level of performance is achieved on the training dataset. An acceptable level of performance may refer to the ML model achieving a pre-defined average reconstruction error over the training dataset (e.g., normalized MSE of the reconstruction error over the training dataset is less than, say, 0.1). Alternatively, it may refer to the ML model achieving a pre-defined value chosen by a user.

In some implementations, a function F(⋅) may be generated by a ML process, such as, for example, supervised learning, reinforcement learning, and/or unsupervised learning. It should further be understood that supervised learning may be done in various ways, such as, for example, using random forests, support vector machines, neural networks, and the like. By way of non-limiting example, any of the following types of neural networks that may be utilized, including, deep neural networks (DNNs), convolutional neural networks (CNNs), and recurrent neural networks (RNNs), or any other known or future neural network that satisfies the needs of the system. In an implementation using supervised learning the neural networks may be easily integrated into the hardware described in computing device 2500 of FIG. 16 (e.g., in the form of simple vector-matrix multiplications).

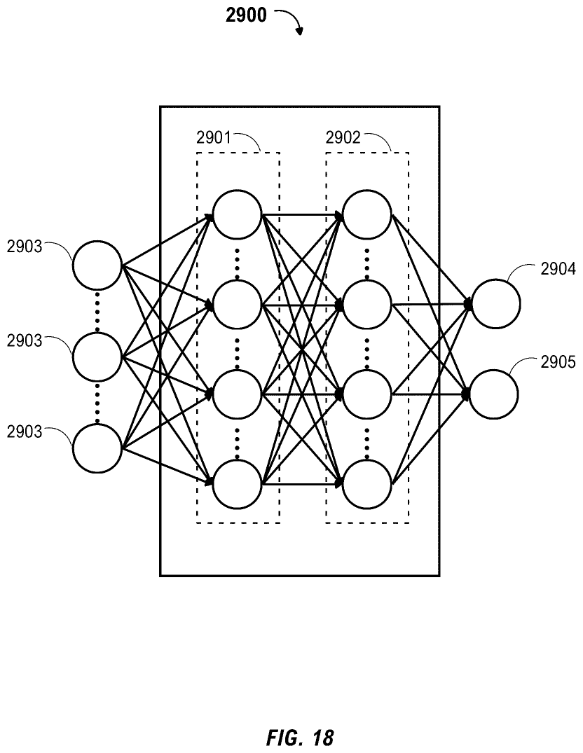

Referring now to FIG. 18, an example neural network 2900 (e.g., DNN) is shown. In some implementations, and as shown, the neural network 2900 may include two hidden layers 2901 and 2902, represented by dashed boxes in FIG. 18. In one implementation, the inputs 2903 may be fed into the neural network 2900. Next, the inputs 2403 may go through a set of hidden layers (e.g., 2901 and/or 2902). Once the inputs 2903 pass though the hidden layers 2901 and/or 2902, they may be output (e.g., as an output layer) as e.g., the likelihoods of a customer response to a one pager 2904; likelihood of fit to a cognitive tension graph 2905; or another output valuable for e.g., document, marketing, and/or narrative results. Possible inputs can include e.g.: framework/pattern/technique type, industry, and/or other data which can impact optimization of narrative generation; or a myriad of other data.

As should be understood by one of ordinary skill in the art, in order for the neural network 2900 to output a proper analysis, it should be trained properly (e.g., with a collection of samples) to accurately extract the likelihood values. If not trained properly, overfitting (e.g., when the NN memorizes the structure of the preambles but is unable to generalize to unseen preamble characteristics) or underfitting (e.g., when the NN is unable to learn a proper function even on the data that it was trained on) may happen. Thus, implementations may exist that prevent overfitting or underfitting, involving a set of well-engineered features that must be extracted from the preamble characteristics.

### Example Methods for Narrative Creation

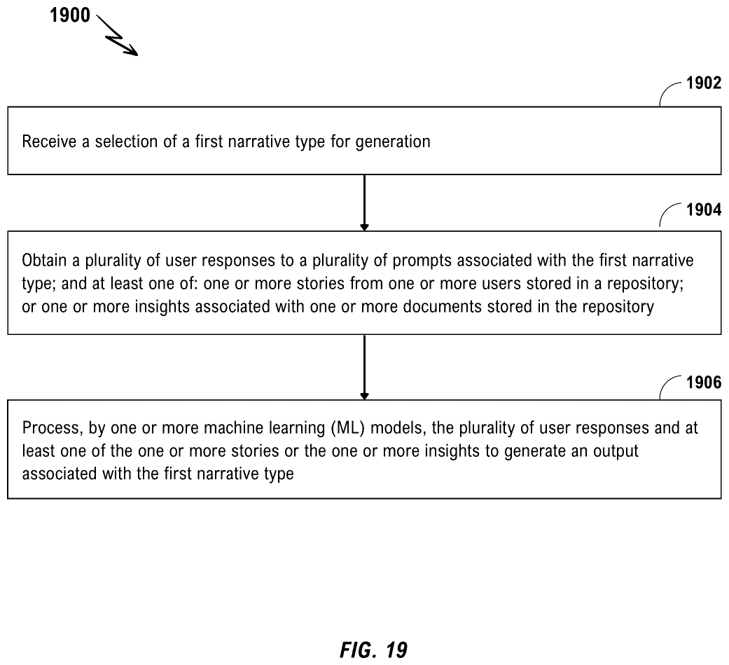

FIG. 19 illustrates an example method 1900 (e.g., computer-implemented method) for narrative creation. In one aspect, method 1900 can be implemented by the narrative creation system 130 of FIG. 1A and/or computing device 2500 of FIG. 16.

Method 1900 begins, at block 1902, with receiving a selection of a first narrative type for generation.

Method 1900 proceeds, at block 1904, with obtaining: a plurality of user responses to a plurality of prompts associated with the first narrative type; and at least one of: one or more stories from one or more users stored in a repository; or one or more insights associated with one or more documents stored in the repository.

Method 1900 proceeds, at block 1906, with processing, by one or more ML models, the plurality of user responses and at least one of the one or more stories or the one or more insights to generate an output associated with the first narrative type.

Note that FIG. 19 is just one example of a method, and other methods including fewer, additional, or alternative operations are possible consistent with this disclosure.

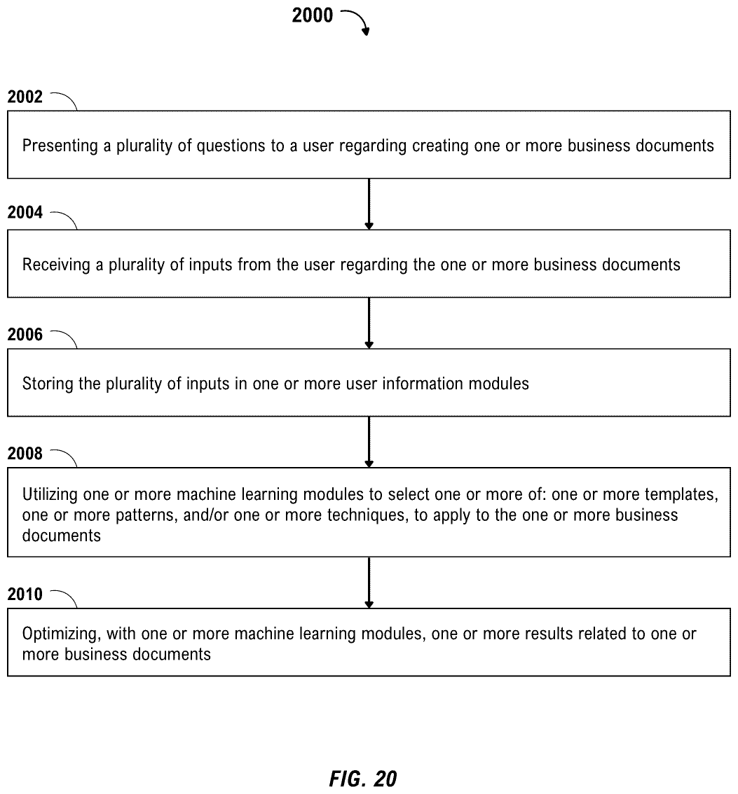

FIG. 20 illustrates an example method 2000 (e.g., computer-implemented method) for creating one or more business documents. In one aspect, method 2000 can be implemented by the narrative creation system 130 of FIG. 1A and/or computing device 2500 of FIG. 16.

Method 2000 begins, at block 2002, with presenting a plurality of questions to a user regarding creating one or more business documents.

Method 2000 proceeds, at block 2004, with receiving a plurality of inputs from the user regarding the one or more business documents.

Method 2000 proceeds, at block 2006, with storing the plurality of inputs in one or more user information modules.

Method 2000 proceeds, at block 2008, with utilizing one or more machine learning modules to select one or more of: one or more templates, one or more patterns, and/or one or more techniques, to apply to the one or more business documents.

Method 2000 proceeds, at block 2010, with optimizing, with one or more machine learning modules, one or more results related to the one or more business documents.

Note that FIG. 20 is just one example of a method, and other methods including fewer, additional, or alternative operations are possible consistent with this disclosure.

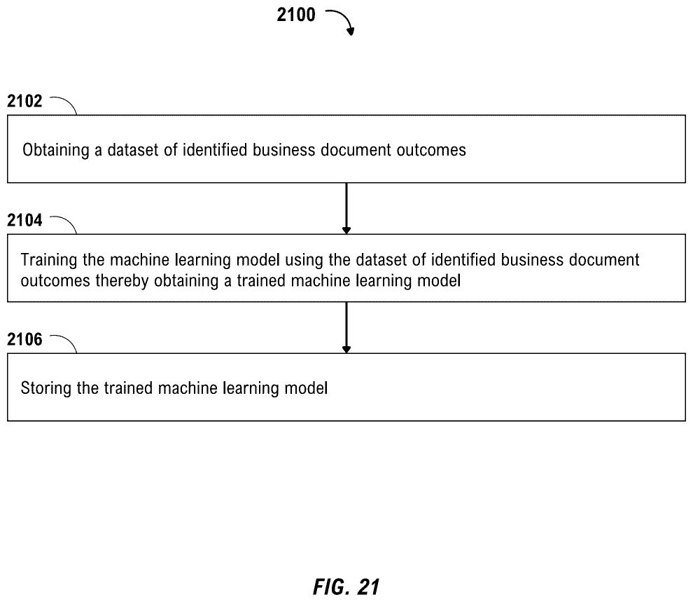

FIG. 21 illustrates an example method 2100 (e.g., computer-implemented method) for training an ML model for optimizing narrative structure of one or more business documents. In one aspect, method 2100 can be implemented by the narrative creation system 130 of FIG. 1A and/or computing device 2500 of FIG. 16.

Method 2100 begins, at block 2102, with obtaining a dataset of identified business document outcomes.

Method 2100 proceeds, at block 2104, with training the ML model using the dataset of identified business document outcomes thereby obtaining a trained machine learning model.

Method 2100 proceeds, at block 2106, with storing the trained ML model.

Note that FIG. 21 is just one example of a method, and other methods including fewer, additional, or alternative operations are possible consistent with this disclosure.

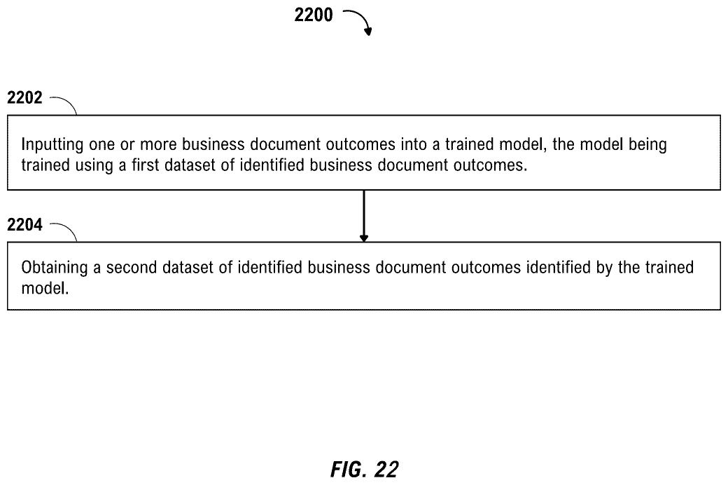

FIG. 22 illustrates an example method 2200 (e.g., computer-implemented method) for obtaining identified business document outcomes. In one aspect, method 2100 can be implemented by the narrative creation system 130 of FIG. 1A and/or computing device 2500 of FIG. 16.

Method 2200 begins, at block 2202, with inputting one or more business document outcomes into a trained model, the model being trained using a first dataset of identified business document outcomes.

Method 2200 proceeds, at block 2204, with obtaining a second dataset of identified business document outcomes identified by the trained model.

Note that FIG. 21 is just one example of a method, and other methods including fewer, additional, or alternative operations are possible consistent with this disclosure.

### EXAMPLE CLAUSES

Implementation examples are described in the following numbered clauses:

Clause 1: A method, comprising: receiving a first selection of a first narrative type for generation; obtaining: a plurality of user responses to a plurality of prompts associated with the first narrative type; and at least one of: one or more stories from one or more users stored in a repository; or one or more insights associated with one or more documents stored in the repository; and processing, by one or more machine learning (ML) models, the plurality of user responses and at least one of the one or more stories or the one or more insights to generate an output associated with the first narrative type.

Clause 2: The method of Clause 1, wherein processing, by the one or more ML models, the plurality of user responses and at least one of the one or more stories or the one or more insights to generate the output associated with the first narrative type comprises: generating the output according to at least one of: one or more frameworks; one or more patterns; or one or more techniques.

Clause 3: The method of Clause 2, wherein the one or more frameworks comprise at least one of: And, But, Therefore (ABT), a Hero's Journey, a Pixar structure, or Challenge, Action, Results (CAR).

Clause 4: The method of any one of Clauses 2-3, wherein the one or more patterns comprise at least one of: Leveling Up, Reinventing the Future, Seizing the Opportunity, Aligning the Ecosystem, Mining for Insights, Solving the Problem, Learning from Failure, Sharing the Origin, Discovering Happy Accidents, or Breaking Through At Last.

Clause 5: The method of any one of Clauses 2-4, wherein the one or more techniques comprise at least one of: proprietary templates, Wharton Innovation Narrative, The Narrative Arc, proprietary feedback templates, proprietary stakeholder alignment, Technological Reflectiveness Scale, Metaphors for Incremental Innovation, Story-led Innovation vs. Innovation-led Stories, Storytelling for Radically New Products, or Serial Position Effect.

Clause 6: The method of any one of Clauses 1-5, wherein: each of the one or more stories and the one or more insights are stored in the repository as a node in a graph comprising a plurality of nodes; and at least one pair of nodes of the plurality of nodes are connected by a respective edge indicating a relatedness between the at least one pair of nodes.

Clause 7: The method of Clause 6, wherein obtaining at least one of: the one or more stories or the one or more insights comprises obtaining, by a retrieval engine implementing graph-based retrieval augmented generation (RAG), at least one of: the one or more stories or the one or more insights.

Clause 8: The method of Clause 7, wherein obtaining, by the retrieval engine, at least one of: the one or more stories or the one or more insights comprises: for each respective node of the plurality of nodes: generating a respective relatedness score indicating a relatedness of a respective story of a respective insight associated with the respective node to the plurality of user responses; and obtaining at least one of the one or more stories or the one or more insights based on the respective relatedness score associated with each respective node associated with each of the at least one of the one or more stories or the one or more insights being greater than a relatedness threshold.

Clause 9: The method of any one of Clauses 1-8, further comprising: identifying one or more documents that are relevant to the first narrative type; generating the one or more insights based on the one or more documents; and storing the one or more insights in the repository.

Clause 10: The method of any one of Clauses 1-9, further comprising: obtaining a second selection of one or more story types; sending, to one or more contributors, a request to provide a plurality of responses to a plurality of prompts associated with the one or more story types; obtaining, from the one or more contributors, the plurality of responses to the plurality of prompts associated with the one or more story types; generating the one or more stories based on the plurality of responses to the plurality of prompts associated with the one or more story types; and storing the one or more stories in the repository.

Clause 11: The method of any one of Clauses 1-10, further comprising: providing, via a user interface, the plurality of prompts to a user.

Clause 12: A processing system, comprising: a memory comprising computer-executable instructions; and a processor configured to execute the computer-executable instructions and cause the processing system to perform a method in accordance with any one of Clauses 1-11.

Clause 13: A processing system, comprising means for performing a method in accordance with any one of Clauses 1-11.

Clause 14: A non-transitory computer-readable medium storing program code for causing a processing system to perform the steps of any one of Clauses 1-11.

Clause 15: A computer program product embodied on a computer-readable storage medium comprising code for performing a method in accordance with any one of Clauses 1-11.

### Additional Considerations

Although the computing devices described herein (e.g., network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages-so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

What is claimed is:

1. A processing system, comprising:
a memory comprising computer-executable instructions; and
a processor configured to execute the computer-executable instructions and cause the processing system to:
receive a first selection of a first narrative type for generation;
obtain:
a plurality of user responses to a plurality of prompts associated with the first narrative type; and
at least one of:
one or more stories from one or more users stored in a repository; or
one or more insights associated with one or more documents stored in the repository; and
process, by one or more machine learning (ML) models, the plurality of user responses and at least one of the one or more stories or the one or more insights to generate an output associated with the first narrative type.

2. The processing system of claim 1, wherein to process, by the one or more ML models, the plurality of user responses and at least one of the one or more stories or the one or more insights to generate the output associated with the first narrative type, the processor is configured to execute the computer-executable instructions and cause the processing system to:
generate the output according to at least one of:
one or more frameworks;
one or more patterns; or
one or more techniques.

3. The processing system of claim 2, wherein the one or more frameworks comprise at least one of:
And, But, Therefore (ABT),
a Hero's Journey,
a Pixar structure, or
Challenge, Action, Results (CAR).

4. The processing system of claim 2, wherein the one or more patterns comprise at least one of:
Leveling Up,
Reinventing the Future,
Seizing the Opportunity,
Aligning the Ecosystem,
Mining for Insights,
Solving the Problem,
Learning from Failure,
Sharing the Origin,
Discovering Happy Accidents, or
Breaking Through At Last.

5. The processing system of claim 2, wherein the one or more techniques comprise at least one of:
proprietary templates,
Wharton Innovation Narrative,
The Narrative Arc,
proprietary feedback templates,
proprietary stakeholder alignment,
Technological Reflectiveness Scale,
Metaphors for Incremental Innovation,
Story-led Innovation vs. Innovation-led Stories,
Storytelling for Radically New Products, or
Serial Position Effect.

6. The processing system of claim 1, wherein:
each of the one or more stories and the one or more insights are stored in the repository as a node in a graph comprising a plurality of nodes; and
at least one pair of nodes of the plurality of nodes are connected by a respective edge indicating a relatedness between the at least one pair of nodes.

7. The processing system of claim 6, wherein to obtain at least one of: the one or more stories or the one or more insights, the processor is configured to execute the computer-executable instructions and cause the processing system to obtain, by a retrieval engine implementing graph-based retrieval augmented generation (RAG), at least one of: the one or more stories or the one or more insights.

8. The processing system of claim 7, wherein to obtain, by the retrieval engine, at least one of: the one or more stories or the one or more insights, the processor is configured to execute the computer-executable instructions and cause the processing system to:
for each respective node of the plurality of nodes:
generate a respective relatedness score indicating a relatedness of a respective story of a respective insight associated with the respective node to the plurality of user responses; and
obtain at least one of the one or more stories or the one or more insights based on the respective relatedness score associated with each respective node associated with each of the at least one of the one or more stories or the one or more insights being greater than a relatedness threshold.

9. The processing system of claim 1, wherein the processor is configured to execute the computer-executable instructions and use the processing system to:
identify one or more documents that are relevant to the first narrative type;
generate the one or more insights based on the one or more documents; and
store the one or more insights in the repository.

10. The processing system of claim 1, wherein the processor is configured to execute the computer-executable instructions and use the processing system to:
obtain a second selection of one or more story types;
send, to one or more contributors, a request to provide a plurality of responses to a plurality of prompts associated with the one or more story types;
obtain, from the one or more contributors, the plurality of responses to the plurality of prompts associated with the one or more story types;
generate the one or more stories based on the plurality of responses to the plurality of prompts associated with the one or more story types; and
store the one or more stories in the repository.

11. The processing system of claim 1, wherein the processor is configured to execute the computer-executable instructions and cause the processing system to:
provide, via a user interface, the plurality of prompts to a user.

12. A method for narrative creation, comprising:
receiving a first selection of a first narrative type for generation;
obtaining:
a plurality of user responses to a plurality of prompts associated with the first narrative type; and
at least one of:
one or more stories from one or more users stored in a repository; or
one or more insights associated with one or more documents stored in the repository; and
processing, by one or more machine learning (ML) models, the plurality of user responses and at least one of the one or more stories or the one or more insights to generate an output associated with the first narrative type.

13. The method of claim 12, wherein processing, by the one or more ML models, the plurality of user responses and at least one of the one or more stories or the one or more insights to generate the output associated with the first narrative type comprises:
generating the output according to at least one of:
one or more frameworks;
one or more patterns; or
one or more techniques.

14. The method of claim 13, wherein the one or more frameworks comprise at least one of:
And, But, Therefore (ABT),
a Hero's Journey,
a Pixar structure, or
Challenge, Action, Results (CAR).

15. The method of claim 13, wherein the one or more patterns comprise at least one of:
Leveling Up,
Reinventing the Future,
Seizing the Opportunity,
Aligning the Ecosystem,
Mining for Insights,
Solving the Problem,
Learning from Failure,
Sharing the Origin,
Discovering Happy Accidents, or
Breaking Through At Last.

16. The method of claim 13, wherein the one or more techniques comprise at least one of:
proprietary templates,
Wharton Innovation Narrative,
The Narrative Arc,
proprietary feedback templates,
proprietary stakeholder alignment,
Technological Reflectiveness Scale,
Metaphors for Incremental Innovation,
Story-led Innovation vs. Innovation-led Stories,
Storytelling for Radically New Products, or
Serial Position Effect.

17. The method of claim 12, wherein:
each of the one or more stories and the one or more insights are stored in the repository as a node in a graph comprising a plurality of nodes; and
at least one pair of nodes of the plurality of nodes are connected by a respective edge indicating a relatedness between the at least one pair of nodes.

18. The method of claim 17, wherein obtaining at least one of: the one or more stories or the one or more insights comprises obtaining, by a retrieval engine implementing graph-based retrieval augmented generation (RAG), at least one of: the one or more stories or the one or more insights.

19. The method of claim 18, wherein obtaining, by the retrieval engine, at least one of: the one or more stories or the one or more insights comprises:
for each respective node of the plurality of nodes:
generating a respective relatedness score indicating a relatedness of a respective story of a respective insight associated with the respective node to the plurality of user responses; and
obtaining at least one of the one or more stories or the one or more insights based on the respective relatedness score associated with each respective node associated with each of the at least one of the one or more stories or the one or more insights being greater than a relatedness threshold.

20. The method of claim 12, further comprising:
identifying one or more documents that are relevant to the first narrative type;
generating the one or more insights based on the one or more documents; and
storing the one or more insights in the repository.
